(19) United States
(12) Patent Application Publication
(10) Pub. No.: US 2022/0148104 A1
(43) Pub. Date: May 12, 2022

(54) COMPUTER IMPLEMENTED METHODS AND SYSTEMS FOR PROVIDING A MARKETPLACE FOR CHILDCARE RELATED SERVICES BETWEEN A PLURALITY OF FIRST USERS, A PLURALITY OF SECOND USERS, AND A PLURALITY OF THIRD USERS THROUGH A USER INTERFACE AND A GRAPHICAL DISPLAY

(71) Applicant: In Child Care Aura, LLC, Brooklyn, NY (US)

(72) Inventor: Galina Shelomentseva, Brooklyn, NY (US)

(21) Appl. No.: 17/524,507

(22) Filed: Nov. 11, 2021

Related U.S. Application Data
(60) Provisional application No. 63/112,680, filed on Nov. 12, 2020.

(51) Int. Cl. G06Q 50/10; G06Q 30/00; G06F 16/9535; G06F 3/04883

(52) U.S. Cl. CPC G06Q 50/10; G06F 3/04883; G06F 16/9535; G06Q 30/018

(57) ABSTRACT

A computer implemented method for providing a marketplace for childcare related services between first users, second users, and third users is disclosed. The first users are generally parents, the second users are generally childcare providers, and the third users are generally vendors and professionals. The system sends with a transceiver, over a communications network to a user computing device, user graphical display data for displaying a user graphical display having a map and a graphical indicator that corresponds to each of the plurality of user records that satisfy user search parameters. The graphical indicator may include information corresponding to the user record, such as the user name, user services, user geographic location, user rating, user child information, etc. The system is configured such that first users can search for second users, second users can search for first users and third users, and third users can search for second users.

### CROSS-REFERENCE TO RELATED APPLICATIONS

This application claims the benefit of the filing date of U.S. Provisional Application Ser. No. 63/112,680 titled “Online and Mobile Search-Analytical System “Child Care Match”” and filed Nov. 12, 2020, and the subject matter of which is incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present invention relates to the field of computer implemented methods, and more specifically to the field of methods and systems optimizing childcare search services.

### BACKGROUND

The childcare marketplace in the United States is fractured and inefficient. Parents in search of a solution must go through a time-consuming and frustrating process to find the right caregiver through a range of methods, online and offline. Similarly, childcare Providers have no unified marketplace dedicated to their business needs, marketing, vendors, and talent; therefore, costing them time and money that could be better spent on educating the children in their care.

The limitations of the prior art make searching for proper childcare services a frustrating and time-consuming process. Parents in the market for childcare must account for a variety of factors when searching for a childcare provider. These factors comprise of costs, location, education, experience, needs, services, background checks, and more. Similarly, childcare providers lack a proper venue for networking, marketing, and connecting with potential clients.

For parents, the need for proper childcare services is universal. Parents may require daily services while they are away for work or trips, or emergency services for unforeseen events such as accidents or funerals. However, the amount of time and effort that go into finding such services is tremendous. The need for childcare services warrants extensive research because the parent needs a certain amount of knowledge and sense of security before they can trust their children in the hands of a potential stranger.

The searches parameters conducted are usually a combination of online searching, phone calls, in-person visits to care facilities, and word of mouth. The research is so extensive because a variety of factors need to be considered. Parents must consider whether they want a provider for at-home services or a provider with their own care facility. If the provider has their own facility, the parent needs to consider the facility's location and proximity to their home or work, the size, safety features, number of children being cared there, etc. Parents also need to know about the person or people who will be caring for their child. Qualities such as education, experience, reputation, and personality may all play a role in deciding who a parent wants to hire. The provided services also play a huge role since not all parents have the same needs when it comes to childcare. Parents' needs can vary from one-time care, to daily, overnight, or long term. Some may be looking for a service that provides educational needs such as teaching or tutoring. Parents may also want a facility that allows their child to interact and play with other children in their age group to help develop their interpersonal skills. Finally, parents must consider the cost associated with such services. Childcare can be an expensive and cumbersome for many parents, so it is understandable that they would need to compare and evaluate the costs associated with these services.

For the childcare service providers, the challenges come from the lack of a unified marketplace dedicated to their business needs, marketing, vendors, and talent. Professionals need a dedicated job board to find work. Vendors require a procurement platform in the childcare marketplace. Service providers need to dedicate a significant amount of time and money for purposes such as developing and advertising market services, reaching out to customers, hiring talent, and finding vendors. To do so, they need to navigate through a vast number of websites and other resources. This costs time and money that could better spent elsewhere.

As a result, there exists a need for improvements over the prior art and more particularly for a unified online marketplace for the childcare market, where service providers and consumers can more easily connect with each other.

### SUMMARY

A computer implemented method for providing a marketplace for childcare related services between a plurality of first users and a plurality of second users is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

The system provides an analytical module for processing information. It accepts customer requests to find Providers for children, as well as requests from the providers to find customers, employees, procurement proposals and dispatch advertisements and information. Then, the analytical module processes the requests and selects the appropriate requests and proposals to the respective users, matches them, and instantly connects the parties via listings on the map search results page, on detailed provider listings, via targeted promotions on the platform, and targeted offers.

Because there is no one unified online system for all the parties of childcare market including a map search of providers, professional marketplace, procurement platform, or rating system, there is also no standardization of information on the market. This means a dig through several systems that requires much more work on the readers' part to analyze the information, and no ability for vendors and providers to analyze the market. The system creates an easy to use and convenient marketplace for customers, compelling for saving time and costs of providers, attractive for vendors, and productive for Professionals. By combining all of these features and uses into one system, the strength of the system will derive from the network effect of all parties, growing stronger with each new user and becoming unified destination for the childcare market.

In one embodiment, a computer implemented method for providing a marketplace for childcare related services between a plurality of first users and a plurality of second users is disclosed. The system includes generating, with a processor of a computing device, a first user record for each of the plurality of first users and a second user record for each of the plurality of second users. The first user record includes first user data having (1) first user identifying information; (2) a first user geographic location; and (3) first user child information. The second user record includes second user data having (1) second user identifying information (2) a second user geographic location; (3) second user services; and (4) a description of a second user facility. The first user records and the second user records are then stored in a connected database. The transceiver of the computing device sends, over a communications network, sending with a transceiver of the computing device, over a communications network to a first user computing device associated with one of the plurality of first users, first user interface data for providing a first user interface configured for receiving first user search parameters input from the first user computing device, wherein the first user search parameters comprise at least one of: (1) a predetermined geographic location; (2) a searching age range; (3) required second user services; and (4) a minimum second user rating. The transceiver receives, over the communications network from the first user computing device, the first user search parameters, which are then stored in the corresponding first user record. After the first user search parameters are received, the processor determines, based on a plurality of second user records, which of the second user records satisfies the first user search parameters. The transceiver then sends, over the communications network, to the first user computing device, first user graphical display data for displaying a first user graphical display comprising a map and a second user graphical indicator that corresponds to each of the plurality of second user records that satisfy the first user search parameters. The second user graphical indicator includes displaying at least one of: (1) the second user record; (2) the second user identifying information that satisfied the first user search parameters; (3) a second user rating; (4) a second user waiting list; and (5) a second user visitation request. After the second user indicators are displayed on the first user graphical display, the transceiver receives, over the communications network from the first user computing devices, selected second user data, wherein the selected second user data is triggered by a gesture received on the first user graphical display proximate to the selected second user graphical indicator displayed on the first user computing device.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a diagram of an operating environment that supports a system for providing a marketplace for childcare related services between a plurality of first users and a plurality of second users, according to an example embodiment;

FIG. 2 is a schematic illustrating communication between the entities in FIG. 1 in relation to providing the marketplace for childcare related services between a plurality of users;

FIG. 3A is a diagram illustrating a method of generating and storing user records of the plurality of users, according to an example embodiment.

FIG. 3B is a diagram illustrating the method of providing a first user interface for searching and selecting second users, according to an example embodiment.

FIG. 3C is a diagram illustrating the method of receiving a first user communication request from a first user computing device, according to an example embodiment.

FIG. 3D is a diagram illustrating the method of providing a second user interface for searching and selecting first users and second users, according to an example embodiment.

FIG. 3E is a diagram illustrating the method of receiving a second user communication request from the second user computing device, according to an example embodiment.

FIG. 3F is a diagram illustrating the method of providing a third user interface for searching and selecting second users, according to an example embodiment.

FIG. 3G is a diagram illustrating the method of receiving a third user communication request from a second user computing device, according to an example embodiment.

FIG. 4 is a diagram illustrating the method of rating a selected second user, according to an example embodiment.

FIG. 5 is a diagram illustrating the method for joining a wait list of a second user or third user, according to an example embodiment.

FIG. 6 is a diagram for illustrating the method for displaying advertisement material, according to an example embodiment.

FIG. 7 is a diagram illustrating the method for displaying an analytics report, according to an example embodiment.

FIG. 8A illustrates a graphical display for generating a first user record, according to an example embodiment.

FIG. 8B illustrates a graphical display for generating the first user record, according to an example embodiment.

FIG. 8C illustrates a graphical display for generating a first user record, according to an example embodiment.

FIG. 8D illustrates a graphical display for generating a first user record, according to an example embodiment.

FIG. 9A illustrates a graphical display of a stored first user record or profile, according to an example embodiment.

FIG. 9B illustrates a graphical display the stored first user record or profile, according to an example embodiment.

FIG. 10A illustrates a graphical display for generating a second user record or a third user record, according to an example embodiment.

FIG. 10B illustrates a graphical display for generating the second user record or the third user record, according to an example embodiment.

FIG. 10C illustrates a graphical display for generating the second user record or the third user record, according to an example embodiment.

FIG. 10D illustrates a graphical display for generating the second user record or the third user record, according to an example embodiment.

FIG. 11A illustrates a graphical display of a stored second user record or profile, according to an example embodiment.

FIG. 11B illustrates a graphical display of the stored second user record or profile, according to an example embodiment.

FIG. 11C illustrates a graphical display of the stored second user record or profile, according to an example embodiment.

FIG. 12A illustrates a first user graphical display for inputting first user search parameters for second user records, according to an example embodiment.

FIG. 12B illustrates the first user graphical display of the second users that satisfy the first user search parameters having a map and second user graphical indicators, and advertisements, according to an example embodiment.

FIG. 13A illustrates a graphical display of a selected second user record including a communication tool, according to an example embodiment.

FIG. 13B illustrates a graphical display of the selected second user record including services and a description, according to an example embodiment.

FIG. 13C illustrates a graphical display of the selected second user record including ratings and team members, according to an example embodiment.

FIG. 14A illustrates the first user graphical display of a first communication tool for a first user, according to an example embodiment.

FIG. 14B illustrates the second user graphical display of a second communication tool, according to an example embodiment.

FIG. 15 illustrates a graphical display for displaying ratings and reviews of a selected second user, according to an example embodiment.

FIG. 16 illustrates a graphical display for displaying a waiting, according to an example embodiment.

FIG. 17 illustrates a graphical interface for displaying an analytics report of a selected second user, according to an example embodiment.

FIG. 18 illustrates a graphical interface for displaying a calendar, according to an example embodiment.

FIG. 19 is a block diagram of a system including a computing device and other computing devices, according to an exemplary embodiment of present technology.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing computer implemented methods and systems for providing a marketplace for childcare related services. The present invention is poised to reinvent the childcare market through proprietary analytical tools that connect childcare providers with customers, professionals, and vendors in one convenient, unified online platform. For parents, who are the plurality of first users, this means a quick, precise, and trustworthy place to find full-time and part-time childcare, classes, and activities. For care providers, who are the plurality of second users, it means a one-stop solution for hiring talent, finding suppliers, and reaching their customers. For professionals, who are the plurality of third users, it means a dedicated job board to find work. For vendors, who are also the plurality of third users, it means creating a procurement platform in the childcare marketplace. The present invention also reduces website, marketing, and advertising costs and time while providing an efficient marketplace for the childcare industry.

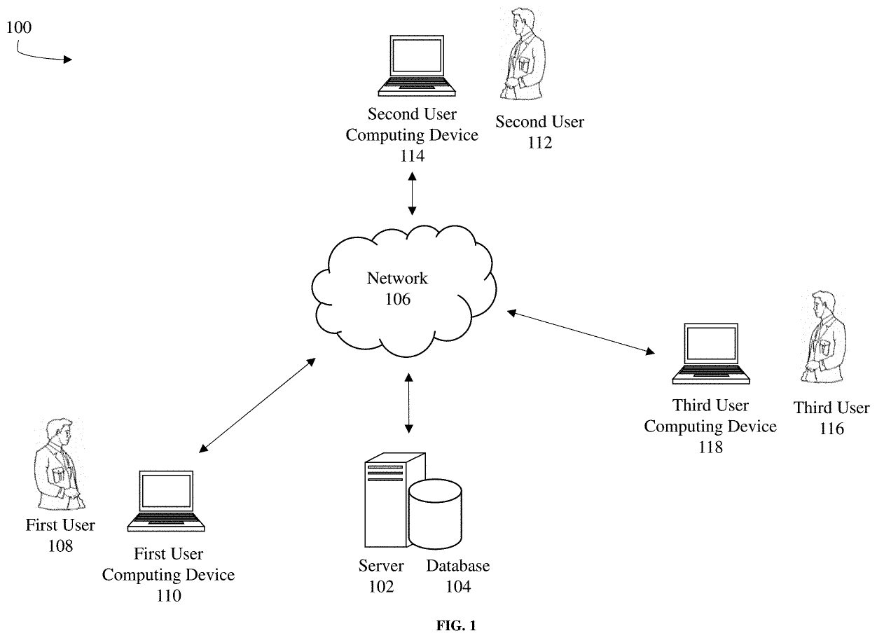

Referring now to the Figures, FIG. 1 is an illustration of a block diagram showing the network architecture of a system and method for providing a marketplace for childcare related services between a plurality of first users and a plurality of second users over a communications network in accordance with the principles of the present invention. The most prominent element of FIG. 1 is the server 102 associated with repository or database 104 and further coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. In one embodiment, network 106 is a secure network wherein communications between endpoints are encrypted so as to ensure the security of the data being transmitted. Server 102 is a central controller or operator for the functionality that executes on at least a first user computing device 110, via various methods.

FIG. 1 further includes the first user computing device, a second user computing device, and in certain embodiments, a third user computing device, which each may be smart phones, mobile phones, tablet computers, handheld computers, laptops, or the like. First user computing device 110 corresponds to first user 108. Second user computing device 114 corresponds to second user 112. Third user computing device 118 corresponds to third user 116. In certain embodiments, the system may communicate between the first user and the second user, over the communications network, where the first user is a parent or parent guardian of a child, and the second user is a provider of childcare services, such as but not limited to, child daycare services, child sports and activity programs, groups for children, after school programs, events oriented for children, and pediatric care providers. Other second users that provide services directed towards children and children related activities and care services are within the spirit and scope of the present disclosure.

FIG. 1 further shows that server 102 includes a database or repository 104, which may be one or more of a relational databases comprising a Structured Query Language (SQL) database stored in a SQL server, a columnar database, a document database and a graph database. Computing devices 110, 114, and 118 may also each include their own database. The repository 104 serves data from a database, which is a repository for data used by server 102 and the mobile devices during the course of operation of the invention.

The database 102 may include a stored record for each of the plurality first users, second users, and third users. The database may further include a stored record for each of the search parameters input on the respective computing device by each user. Generally, the first user is a parent or legal guardian of a child. A first user record may include (1) first user identifying information; (2) a first user geographic location; and (3) first user child information. The first user identifying information may include personal information of the first user. Personal information means information that identifies, relates to, describes, is capable of being associated with, or could reasonably be linked, directly or indirectly, with a particular first user. Personal information includes, but is not limited to, the following if it identifies, relates to, describes, is capable of being associated with, or could be reasonably linked, directly or indirectly, with a particular first user: Identifiers such as a real name, alias, postal address, unique personal identifier, online identifier, Internet Protocol address, email address, account name social security number, driver's license number, passport number, or other similar identifiers; Commercial information, including records of personal property, products or services purchased, obtained, or considered, or other purchasing or consuming histories or tendencies; Biometric Information, such as fingerprint or facial recognition; Internet or other electronic network activity information, including, but not limited to, browsing history, search history, and information regarding a consumer's interaction with an Internet Website, application, or advertisement; Geolocation data; Audio, electronic, visual, thermal, olfactory, or similar information; Professional or employment related information; Education information, defined as information that is not publicly available personally identifiable information; and, Inferences drawn from any of the information to create a profile about a consumer reflecting the consumer's preferences, characteristics, psychological trends, predispositions, behavior, attitudes, intelligence, abilities, and aptitudes. The first user identifying information may further include the telephone number/email address/social network handle of the first user, demographic data for the first user, such as age, sex, income data, race, color, marital status, etc. The first user geographic location may include the address of the first user, or the current location of the first user as determined by the GPS or location-based services of the first user computing device. Additionally, the first user child information may include the number of children that the first user is the parent or legal guardian for, the date of birth for each child, the name of each child, the age of each child, the gender of each child, each child's educational information school, learning advancements or disabilities, child allergies, and child preferred activities such as sports/recess/games. Using the date of birth of each child, the system calculates the current age of the child by calculating with the processor of the system the elapsed period of time between the child's date of birth and the current date. The system then updates the first user record daily to account for the continued aging of the child. As the child ages, the first user search parameters continually change resulting in different results and second user records that satisfy the first user search parameters.

Generally, the second user is a business or company whose goods and services relate to children. Ideally, the second user is a provider of childcare services, such as daycare services and youth programs. However, in certain embodiments, the second user may be a vendor of childcare related products and services or professional specializing in child-oriented services, such as tutors and medical professionals, for example. The providers may be day care centers, early education schools, home-based childcare providers, family day care centers, after-school programs, day camps, summer camps, nannies, and babysitters. The vendors may include those who offer services, equipment, furniture, food, and other supplies to childcare providers. The professionals may include education specialists, contractors, and caregivers who work in the childcare market. Other providers, vendors, and professionals are within the sprit and scope of the disclosure. A second user record may include (1) second user identifying information; (2) a second user geographic location; (3) second user services; (4) a description of a second user facility; (5) a second user price; and (6) second user hours of operation. The second user identifying information may include personal information of the second user. Personal information means information that identifies, relates to, describes, is capable of being associated with, or could reasonably be linked, directly or indirectly, with a particular first user. Personal information includes, but is not limited to, the following if it identifies, relates to, describes, is capable of being associated with, or could be reasonably linked, directly or indirectly, with a particular second user: Identifiers such as a real name, alias, postal address, unique personal identifier, online identifier, Internet Protocol address, email address, account name social security number, driver's license number, passport number, or other similar identifiers; Commercial information, including records of personal property, products or services purchased, obtained, or considered, or other purchasing or consuming histories or tendencies; Biometric Information, such as fingerprint or facial recognition; Internet or other electronic network activity information, including, but not limited to, browsing history, search history, and information regarding a consumer's interaction with an Internet Website, application, or advertisement; Geolocation data; Audio, electronic, visual, thermal, olfactory, or similar information; Professional or employment related information; Education information, defined as information that is not publicly available personally identifiable information; and, Inferences drawn from any of the information to create a profile about a consumer reflecting the consumer's preferences, characteristics, psychological trends, predispositions, behavior, attitudes, intelligence, abilities, and aptitudes. The second user identifying information may further include the telephone number/email address/social network handle/website address of the second user; ownership information of the second user's business, and personal information about the employees working at the second user's business including number of employees and relevant employee experience in the field of childcare, such as in the form of a resume or CV. The second user geographic location may include the address of the second user's business, or the current location of the second user as determined by the GPS or location-based services of the first user computing device. The second user record may also include the goods and services offered by the second user's business; the price of said goods and/or services; the working hours of operation of the second user; offered activities, classes, sports, etc.; whether transportation to and from the second user's facility is offered to the first user; the gender of the child; and the age range for children that the second user's goods and services are directed towards such as, for example, 0-5, 5-10, 10-15, etc. The age range may be depicted as educational grade levels such as K-12, or child growth stages such as toddlers, pre-teens, teenagers, etc. Furthermore, the second user record may include a description of the second user's facility, including the address, as well as include images or photographs of the second user's facility and or goods and services.

In certain embodiments, the system may support a plurality of third users, wherein the third users are the vendors and professionals, and the second users are the providers. A third user record may include any information consistent with the second user record including (1) third user identifying information; (2) a third user geographic location; (3) third user services; (4) third user goods; (5) third user hours of operation; and (6) a third user price. The third user identifying information may include any personal identifying information consistent with this disclosure. It is understood that the personal information described is generally input by each respective user on its respective computing device using the respective user interface and graphical display and the respective user data is sent over the communications network to the server to generate the respective user record which is stored in the connected database.

FIG. 1 shows an embodiment wherein networked computing devices 110, 114, and 118, may interact with server 102 and repository 104 over the network 106. Server 102 includes a software engine that delivers applications, data, program code and other information to networked computing devices 110, 114, and 118. The software engine of server 102 may perform other processes such as audio and/or video streaming or other standards for transferring multimedia data in a stream of packets that are interpreted and rendered by a software application as the packets arrive. It should be noted that although FIG. 1 shows only three networked mobile computing devices 110, 114, and 118, the system of the present invention supports any number of networked mobile computing devices connected via network 118, having at least the first user computing device 110 and the second user computing device 114.

Server 102 also includes program logic comprising computer source code, scripting language code or interpreted language code that is compiled to produce executable file or computer instructions that perform various functions of the present invention. In another embodiment, the program logic may be distributed among more than one of server 102, computing devices 110, 114 and 118, or any combination of the above.

Note that although server 102 is shown as a single and independent entity, in one embodiment of the present invention, the functions of server 102 may be integrated with another entity, such as each of computing devices 110, 114, and 118. Further, server 102 and its functionality, according to a preferred embodiment of the present invention, can be realized in a centralized fashion in one computer system or in a distributed fashion wherein different elements are spread across several interconnected computer systems.

The network architecture of FIG. 1 in accordance with the principles of the disclosed embodiments may give rise to various revenue-generating arrangements. The second user 112 may, for example, pay fees to the operators of server 102 in exchange for the services provided by server 102, i.e., the provision of advertisements and marketing materials to the first computing device 110 of the first users 108 that correspond to second user search parameters.

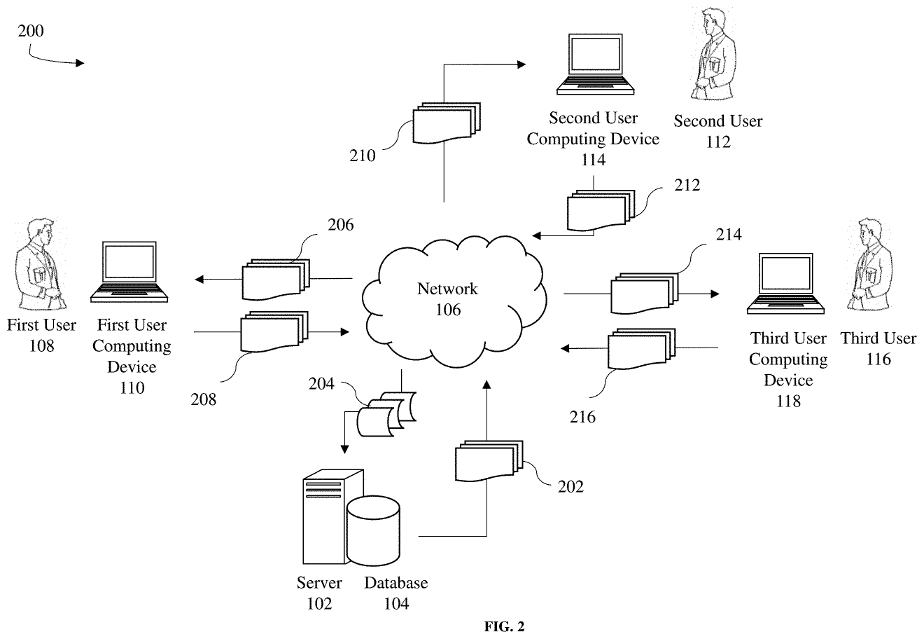

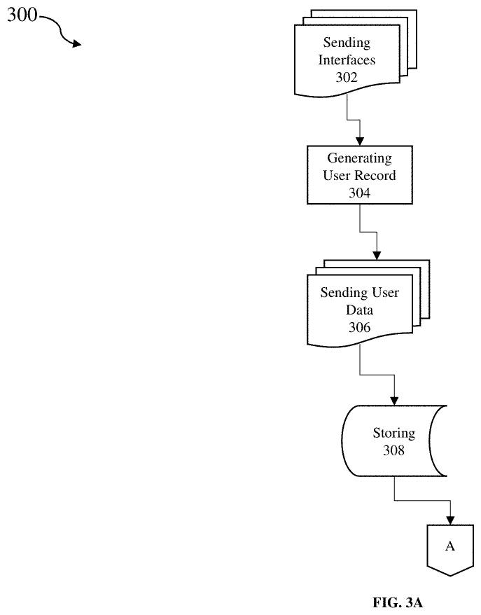

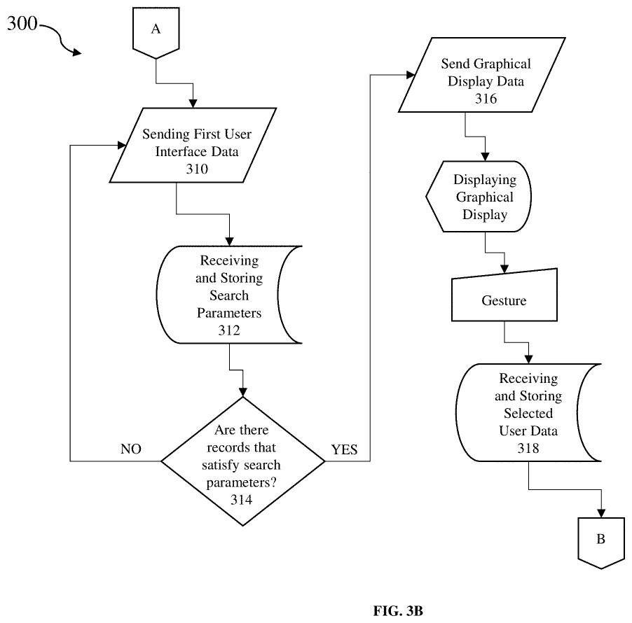

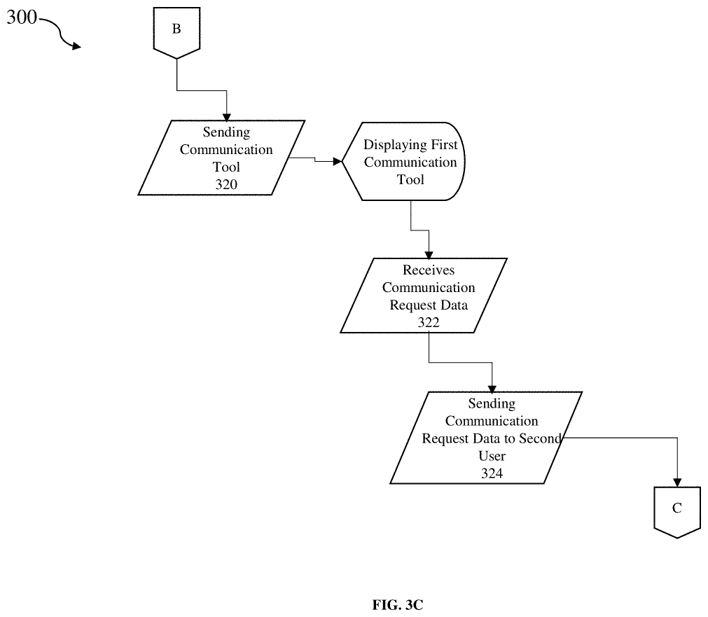

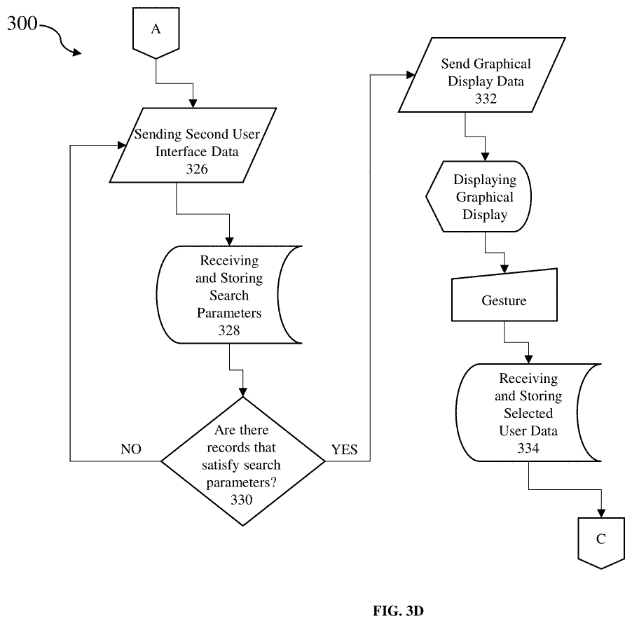

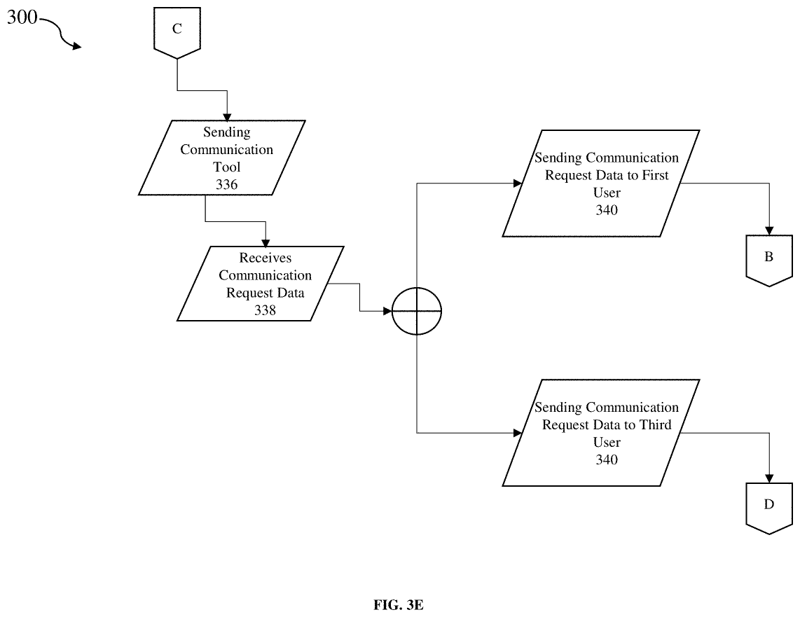

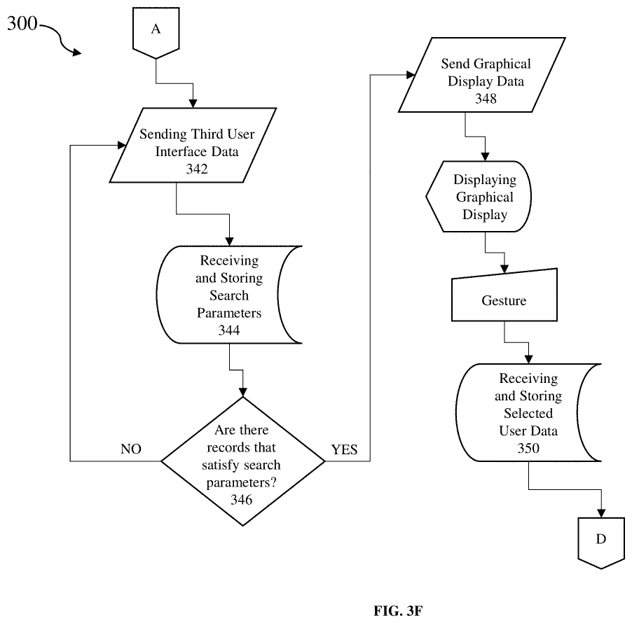

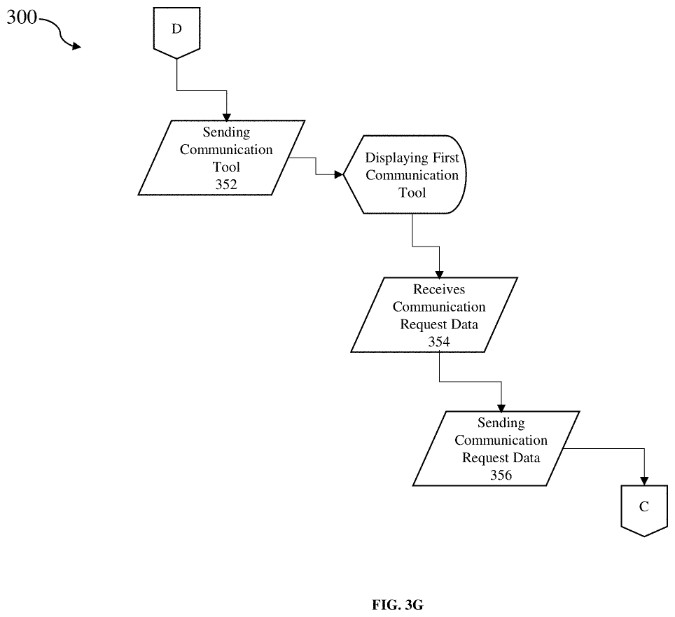

The process for providing a marketplace for childcare related services between a plurality of first users and a plurality of second users over a communications network will now be described with reference to FIGS. 2 through 7. FIGS. 2 through 7 depict, among other things, data flow and control flow in the process for providing a marketplace for childcare related services between a plurality of first users and a plurality of second users over a communications network 106, according to one embodiment. It is understood that in FIG. 2, the data packets 202, 206, 209, 212, 214, 216 are used to show the transmission of data and may used at different stages of the process. With reference to FIG. 3, the process of the disclosed embodiments begins with step 302 (see flowchart 300), wherein the server 102 sends a data packet 202 configured for providing a graphical interface on each of the computing devices 110, 114, and 118, or the plurality of users, of which data packet 202 may be received by each of the computing devices as data packets 206, 210, and 214 respectively. It is understood that the server may send data packet 202 having data directed towards at least one computing device of the plurality of computing devices. It is further understood that each step of process 300 may operate concurrently or independently with another step of the process because the system may support any number of a plurality of users. The graphical interface on each of the computing devices 110, 114, and 118 may include a web browser. The web browser may be configured for sending the communications originating from and received by the server 102 and the computing devices 110, 114, and 118. As described in greater detail below, the first user computing device 110, the second user computing device 114, and the third user computing device 118, may each be in communication with the server 102, a website server that delivers web pages to the users 108, 112, and 116. Web pages (sometimes referred to herein as, “graphical displays”) may be sent via communications including hypertext markup language (“HTML”), cascading style sheets (“CSS”), and JavaScript files, among others. Additional communications between the various device entities (110, 114, and 118) may include various types of data transfer. The data may be provided in a variety of suitable formats, such as one or more of extensible markup language (“XML”), JavaScript object notation (“JSON”), and other lesser used formats such as YAML (standing for a recursive definition of “YAML Ain't. Markup Language,” and referring to a human-readable data-serialization language). Data objects (e.g., JSON, XML) received by the web browser may be displayed according to accompanying HTML, CSS, and/or JavaScript, depending on the context.

It is understood that in today's modern internet that web pages may be delivered to the user in a variety of different ways. For instance, web pages may be delivered as static web pages, as was most common in the past. For example, each web page may have a particular route (e.g., “/home” or “/login” routes) that corresponds to a web page that is delivered by the first server 104. Conversely, modern front-end frameworks such as REACT®, VUE®, and ANGULAR®, among others, allow web designers to deliver fully fledged applications. In other words, the various routes of a website may be delivered in a single package (e.g., on a first loading of the website) to the web browser, as opposed to the request-response used to deliver static websites. In this way, dynamic websites designed using such front-end frameworks may require fewer communications between the user's devices 110, 114, and 118 and the server 102 to simply load the user interfaces of the website. Regardless of the type of website (static or dynamic), the described methods herein are applicable.

In step 304, the processor of the computing device, where the computing device is the first user computing device 110, generates a first user record for the first user. In embodiments where there is a plurality of first users, each respective computing device will generate a first user record for each of the first users. Likewise, the processor of the computing device, where the computing device is the second user computing device 114 or the third user computing device 118, generates a second user record for the second user and a third user record for the third user, respectively. In embodiments where there is a plurality of second users or a plurality of third users, each respective computing device will generate a user record for each of the users. It should be noted that although FIG. 2 shows only three networked mobile computing devices 110, 114, and 118, the system of the present invention supports any number of networked mobile computing devices connected via network 106 and in communication with the sever 102, including embodiments not having the third user computing device.

In step 306, the first user computing device sends, using a transceiver of the first user computing device, data packet 208 to the server 102 across the network 106 which is stored on the connected database 104. In step 306, data packet 308 incudes first user data of the first user record which may include one or more of the first users identifying information, first user geographic location, and first user child information. The first user data may include information configured to display the first user record on a computing device. Moreover, the first user data may include the personal information of the first user. Personal information means information that identifies, relates to, describes, is capable of being associated with, or could reasonably be linked, directly or indirectly, with a particular first user. Personal information includes, but is not limited to, the following if it identifies, relates to, describes, is capable of being associated with, or could be reasonably linked, directly or indirectly, with a particular first user: Identifiers such as a real name, alias, postal address, unique personal identifier, online identifier, Internet Protocol address, email address, account name social security number, driver's license number, passport number, or other similar identifiers; Commercial information, including records of personal property, products or services purchased, obtained, or considered, or other purchasing or consuming histories or tendencies; Biometric Information, such as fingerprint or facial recognition; Internet or other electronic network activity information, including, but not limited to, browsing history, search history, and information regarding a consumer's interaction with an Internet Website, application, or advertisement; Geolocation data; Audio, electronic, visual, thermal, olfactory, or similar information; Professional or employment related information; Education information, defined as information that is not publicly available personally identifiable information; and, Inferences drawn from any of the information to create a profile about a consumer reflecting the consumer's preferences, characteristics, psychological trends, predispositions, behavior, attitudes, intelligence, abilities, and aptitudes. The first user data may further include the telephone number/email address/social network handle of the first user, demographic data for the first user, such as age, sex, income data, race, color, marital status, etc. The first user data may include the first user geographic location which may include the address of the first user, or the current location of the first user as determined by the GPS or location-based services of the first user computing device. Additionally, the first user data may include the first user child information having the number of children that the first user is the parent or legal guardian for, the date of birth for each child, the name of each child, the age of each child, each child's educational information school, learning advancements or disabilities, child allergies, and child preferred activities such as sports/recess/games.

The first user data is received by the server and stored as data packet 204 in the connected database. Similarly, in step 306, the second user computing device sends, using a transceiver of the second user computing device, data packet 212 to the server 102 across the network 106 which is stored on the connected database 104. In step 306, data packet 212 incudes second user data of the second user record which may include one or more of the second users identifying information, second user geographic location, second user services, a description of a second user facility, second user price, and second user hours of operation. The second user data may include information configured to display the second user record on a computing device. Moreover, the second user data may include personal information of the second user. Personal information means information that identifies, relates to, describes, is capable of being associated with, or could reasonably be linked, directly or indirectly, with a particular first user. Personal information includes, but is not limited to, the following if it identifies, relates to, describes, is capable of being associated with, or could be reasonably linked, directly or indirectly, with a particular second user: Identifiers such as a real name, alias, postal address, unique personal identifier, online identifier, Internet Protocol address, email address, account name social security number, driver's license number, passport number, or other similar identifiers; Commercial information, including records of personal property, products or services purchased, obtained, or considered, or other purchasing or consuming histories or tendencies; Biometric Information, such as fingerprint or facial recognition; Internet or other electronic network activity information, including, but not limited to, browsing history, search history, and information regarding a consumer's interaction with an Internet Website, application, or advertisement; Geolocation data; Audio, electronic, visual, thermal, olfactory, or similar information; Professional or employment related information; Education information, defined as information that is not publicly available personally identifiable information; and, Inferences drawn from any of the information to create a profile about a consumer reflecting the consumer's preferences, characteristics, psychological trends, predispositions, behavior, attitudes, intelligence, abilities, and aptitudes. The second user data may further include the telephone number/email address/social network handle/website address of the second user; ownership information of the second user's business, and personal information about the employees working at the second user's business including number of employees and relevant employee experience in the field of childcare, such as in the form of a resume or CV. The second user data may have geographic location including the address of the second user's business, or the current location of the second user as determined by the GPS or location-based services of the first user computing device. The second user data may also include the goods and services offered by the second user's business; the price of said goods and/or services; the working hours of operation of the second user; offered activities, classes, sports, etc.; whether transportation to and from the second user's facility is offered to the first user; and the age range for children that the second user's goods and services are directed towards such as, for example, 0-5, 5-10, 10-15, etc. The age range may be depicted as educational grade levels such as K-12, or child growth stages such as toddlers, pre-teens, teenagers, etc. Furthermore, the second user data may include a description of the second user's facility, including the address, as well as include images or photographs of the second user's facility and or goods and services. The description of the second user's facility may also include other information about the facility and the capabilities of the facility.

The second user data is received by the server and stored as data packet 204 in the connected database. Moreover, in embodiments with the third user and the third user computing device, step 306 includes sending, using a transceiver of the third user computing device, data packet 216 to the server 102 across the network 106 which is stored on the connected database 104. In step 306, data packet 216 incudes third user data of the third user record which may include one or more of the third users identifying information, third user geographic location, third user services, third user goods, third user hours, and third user price. The third user services may include services provided by the user. The third user data may include information configured to display the third user record on a computing device. Moreover, the third user data may include personal information of the third user. Personal information means information that identifies, relates to, describes, is capable of being associated with, or could reasonably be linked, directly or indirectly, with a particular first user. Personal information includes, but is not limited to, the following if it identifies, relates to, describes, is capable of being associated with, or could be reasonably linked, directly or indirectly, with a particular second user: Identifiers such as a real name, alias, postal address, unique personal identifier, online identifier, Internet Protocol address, email address, account name social security number, driver's license number, passport number, or other similar identifiers; Commercial information, including records of personal property, products or services purchased, obtained, or considered, or other purchasing or consuming histories or tendencies; Biometric Information, such as fingerprint or facial recognition; Internet or other electronic network activity information, including, but not limited to, browsing history, search history, and information regarding a consumer's interaction with an Internet Website, application, or advertisement; Geolocation data; Audio, electronic, visual, thermal, olfactory, or similar information; Professional or employment related information; Education information, defined as information that is not publicly available personally identifiable information; and, Inferences drawn from any of the information to create a profile about a consumer reflecting the consumer's preferences, characteristics, psychological trends, predispositions, behavior, attitudes, intelligence, abilities, and aptitudes. The third user data may further include the telephone number/email address/social network handle/website address of the second user; ownership information of the second user's business, and personal information about the employees working at the second user's business including number of employees and relevant employee experience in the field of childcare, such as in the form of a resume or CV. The third user data may have geographic location including the address of the third user's business, or the current location of the second user as determined by the GPS or location-based services of the first user computing device. The third user data may also include the goods and services offered by the second user's business; the price of said goods and/or services; the working hours of operation of the second user; offered activities, classes, sports, etc.; whether transportation to and from the second user's facility is offered to the first user; and the age range for children that the second user's goods and services are directed towards such as, for example, 0-5, 5-10, 10-15, etc. The age range may be depicted as educational grade levels such as K-12, or child growth stages such as toddlers, pre-teens, teenagers, etc. Furthermore, the third user data may include a description of the third user's facility, including the address, as well as include images or photographs of the third user's facility and or goods and services. The user data is received by the server and stored as data packet 204 in the connected database.

At step 308, the system stores each of the first user record, the second user record, and the third user record in the connected database 104 as stored record 204. The stored records may be later accessed by the server. After storing the records in the connected database, the system at step 310, with a transceiver of the computing device, sends over the communications network to the first user computing device associated with one of the pluralities of first users, first user interface data in data packet 202, which is then transmitted to the first user computing device and may be received as data packet 206. Data packet 206, includes the first user interface data for providing a first user interface. The first user interface is configured for receiving first user search parameters input from the first user computing device. The first user interacts with, or provides commands to, the first user computing device to input the first user search parameters. The first user search parameters may include certain parameters of the second user record. The parameters may for example, include a predetermined geographic area, such as a zip code or radius from the first user's geographic location; the first user's child information; the second user's age range; etc. The first user search parameters are configured to be sent over the communications network to the server for the server to be able to identify a stored second user record, retrieve said second user record, and display said second user record on the first user computing device. Other first user search parameters configured to engage the server to retrieve at least one of a corresponding first user record and/or third user record are within the sprit and scope of the disclosure. In step 312, the first user search parameters, data packet 208, are received over the communications network 106 with the transceiver which is then stored as data packet 204 in the connected database, specifically, the first user search parameters are stored in the corresponding first user record of which the data packet 208 originated. The server may access a previously stored data packet 204 having the first user data and the first user record.

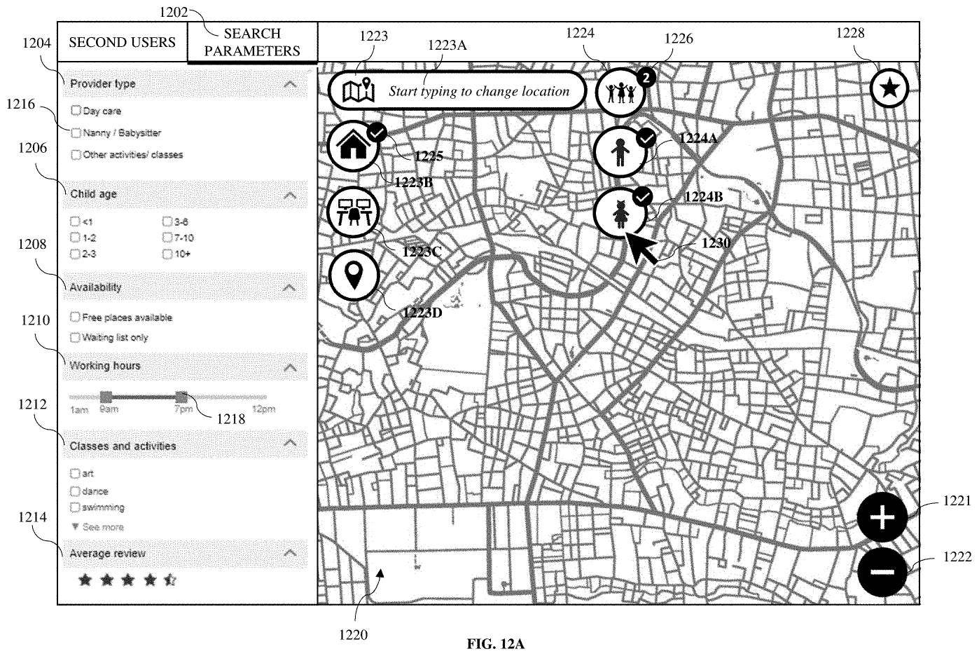

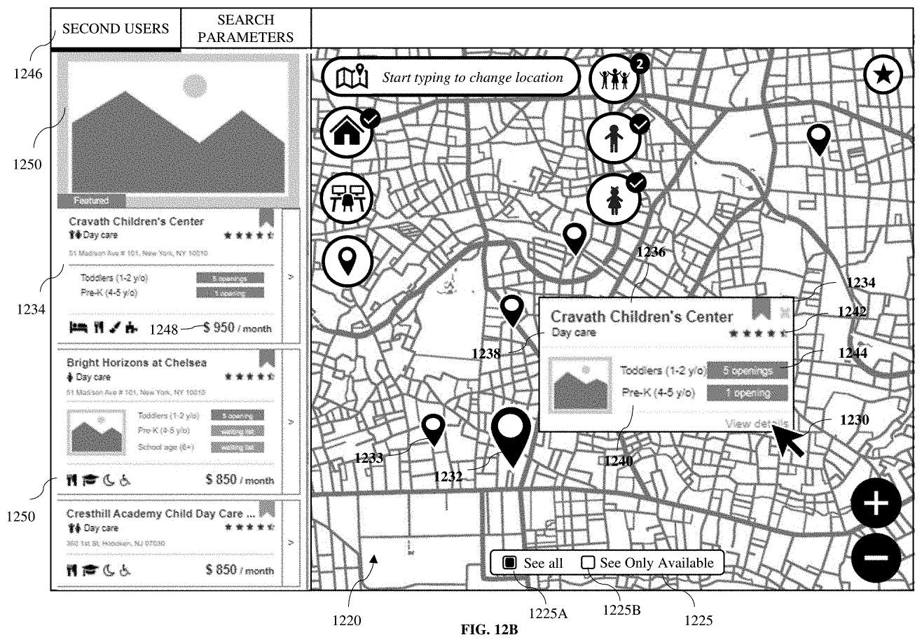

Following step 312, step 314 includes determining with the processor or server 102, based on the plurality of second user records which are stored in the connected database, which of the second user records satisfies the first user search parameters. The system may perform a series of algorithms to compare the data of the first user search parameters to the second user data having the second user record. In this step, the server may access a previously stored record 204 in the database 104. The system may then send with the transceiver, in step 316, data packet 202 having first user graphical display data, transmitted to the first user computing device as data packet 206. The first user graphical display data is data configured for displaying a first user graphical display on the first user computing device. The first user graphical display (further detailed in FIG. 12A through 12B) includes a map and second user graphical indicator that corresponds to each of the plurality of second user records that satisfy the first user search parameters. If the system determines that there are no matching second user records that satisfy the first user search parameters, then the first user graphical display data may include notification data which may engage the first user interface to display a notification prompting the first user to refine the first user search parameters, of which the system will revert to step 310. Otherwise, when the system determines that there is at least one second user record that satisfies the first user searching parameters, then the first user graphical display data will provide for the second user graphical indicator to be disposed on the map of the first user graphical display corresponding the second user geographic location as indicated within the second user record. The second user graphical indicator may include displaying the second user record and a second user rating.

In step 318, the system, receiving with the transceiver, over the communications network from the first user computing device as data packet 208, selected second user data. The selected second user data is triggered by a gesture received on the first user graphical display proximate to the second user graphical indicator displayed on the first user computing device. The selected second user data includes data indicating which second user the first user selected. The selected second user selected may include information about the second user that is to be transmitted to the first user. The gesture may include computer gestures such as a tap, via a touch sensitive interface display, a click, on or near one of the second user graphical indicators. Where the gesture is performed on the first user graphical display having a plurality of second user graphical indicators, the closest second user graphical indicator in proximity to the gesture will be selected and stored on data packet 208 to be sent over the communications network and received by the server 102 and stored as data packet 204 in the connected database.

In step 320, a first communication tool is sent in data packet 202 by the server 102, across the communications network 106, to the first user computing device 110, which is received in data packet 206. The first communication tool is configured such that the first user interacts with, or provides commands to, or inputs a request or message on the first user computing device to communicate with the second user on the second user computing device. Once the request or message is input on the first user computing device, the first user communication request data, in data packet 208, is sent with the transceiver of the first user computing device, over the communications network to the server 102. The server 102, in step 322, receives the first user communication request data and determines with the processor which of the second user records should receive the first user communication request data. The first user communication request data includes at least one of (1) a first user request to the second user, i.e., the selected second user, to visit the second user facility, and/or (2) a first user request to the second user to join a second user waiting list. The requests sent to the user may be in the form of a message, email, SMS notification, or message provides notification to the other user.

The first user communication request data may also information configured to display a graphical notification on the selected second user's computing device having the request of the first user. To determine which of the second users will receive the first user communication request data, the first user communication request data may include embedded information corresponding to the second user record, such as second user identifying information. The server 102, then sends, with the transceiver, in step 324, first user communication request data via data packet 202, over the communications network, to the corresponding second user computing device 114. The second user computing device 114 receives the first user communication request data, in data packet 210, which may be configured for providing a graphical interface, or notification, to enable the second user to engage or interact with the first user via the first user request using the second communication tool. Any such responsive communication by the second user on the second user computing device is sent with the transceiver of the second user computing device to the server 102, over the communications network, which is then correspondingly sent to the first user computing device of which the first user communication request data originated. The communication data between the first user and the second user over the communications network is also consistent with steps 332 through 336 corresponding to each respective computing device and its corresponding data packets.

In step 326, the system, with a transceiver of the computing device, sends over the communications network to the second user computing device associated with one of the pluralities of second users, second user interface data in data packet 202, which is received as data packet 210. Data packet 210, includes the first user interface data for providing a second user interface. The second user interface is configured for receiving second user search parameters input from the second user computing device. The second user interacts with, or provides commands to, the second user computing device to input the second user search parameters. The second user search parameters may include certain parameters of at least one of a first user record and a third user record. The parameters may for example, include a predetermined geographic area, such as a zip code or radius from the second user's geographic location; information corresponding to the first user's child information such as an age range having the age of the first user's child; the goods and or services of the third user. The second user search parameters are configured to be sent over the communications network to the server for the server to be able to identify a stored first user record and/or third user record, retrieve said first user record and/or third user record, and display said first user record and/or third user record on the second user computing device. Other second user search parameters configured to engage the server to retrieve at least one of a corresponding first user record and/or third user record are within the sprit and scope of the disclosure. In step 328, the second user search parameters, data packet 212, are received over the communications network 106 with the transceiver which is then stored as data packet 204 in the connected database, specifically, the second user search parameters are stored in the corresponding second user record of which the data packet 210 originated. The server may access a previously stored data packet 204 having the second user data and the second user record.

Following step 328, step 330 includes determining with the processor or server 102, based on at least one of the pluralities of first user records and the plurality of third user records, which are stored in the connected database, which of the first user records and third user records satisfy the second user search parameters. The system may perform a series of algorithms to compare the data of the second user search parameters to the first user data and the third user data having each of the first user records and third user records, respectively. In this step, the server may access a previously stored record 204 in the database 104.

The system may then send with the transceiver, in step 332, data packet 202 having second user graphical display data, transmitted to the second user computing device as data packet 206. The second user graphical display data is configured for displaying a second user graphical display on the second user computing device. The second user graphical display (further detailed in FIG. 12A through 12B) includes a second map and at least one of a first user graphical indicator that corresponds to each of the plurality of first user records that satisfy the second user search parameters, and a third user graphical indicator that corresponds to each of the plurality of third user records that satisfy the second user search parameters. If the system determines that there is no matching first or third user records that satisfy the second user search parameters, then the second user graphical display data may include notification data which may engage the first user interface to display a notification prompting the second user to refine the second user search parameters, of which the system will revert to step 326. Otherwise, when the system determines that there is at least one first or third user record that satisfies the first user searching parameters, then the second user graphical display data will provide for the first user graphical indicator to be disposed on the second map of the second user graphical display corresponding the first user geographic location as indicated within the first user record and/or the third user graphical indicator to be disposed on the second map of the second user graphical display corresponding the third user geographic location as indicated within the third user record. The third user geographic location, similar to the first user geographic location and second user geographic location may be input by the user into computing device or may captured by the device indicating the location of the geographic location of the user.

The first user graphical indicator may include displaying the first user geographic location, the first user search parameters, and the first user search parameters that correspond to the second user search parameters. Similarly, the third user graphical indicator may include displaying the third user record and the third user record that satisfies the second user search parameters. It is understood that the second user graphical display may include the first user graphical indicator and the third user graphical indicator simultaneously on the same second map. In other embodiments, the second user may interact with the second user computing device to filter the second user graphical display such that the second user graphical display only includes the second map showing only the first user graphical indicators or the third user graphical indicators.

In step 334, the system, receiving with the transceiver, over the communications network from the second user computing device as data packet 212, at least one of selected first user data and selected third user data. The selected first user data is triggered by the gesture received on the second user graphical display proximate to the first user graphical indicator displayed on the second user computing device. The gesture may include computer gestures such as a tap, via a touch sensitive interface display, a click, on or near one of the second user graphical indicators. Where the gesture is performed on the second user graphical display having a plurality of first user graphical indicators, the closest first user graphical indicator in proximity to the gesture will be selected and stored on data packet 212 to be sent over the communications network and received by the server 102 and stored as data packet 204 in the connected database. The selected third user data is triggered by the gesture received on the second user graphical display proximate to the third user graphical indicator displayed on the second user computing device. The gesture may include computer gestures such as a tap, via a touch sensitive interface display, a click, on or near one of the second user graphical indicators. Where the gesture is performed on the second user graphical display having a plurality of third user graphical indicators, the closest third user graphical indicator in proximity to the gesture will be selected and stored on data packet 212 to be sent over the communications network and received by the server 102 and stored as data packet 204 in the connected database. In embodiments having both the first user graphical indicator and the third user graphical indicator on the second map, then the selected user will be the closest graphical indicator, either the first user graphical indicator or the second user graphical indicator, in proximity to the gesture.

In step 336, a second communication tool is sent in data packet 202 by the server 102, across the communications network 106, to the second user computing device 114, which is received in data packet 210. The second communication tool is configured such that the second user interacts with, or provides commands to, or inputs a request or message on the second user computing device to communicate with at least one of the first user computing device on the selected first user and the third user computing device of the selected third user. Once the request or message is input on the second user computing device, second user communication request data, in data packet 212, is sent with the transceiver of the second user computing device, over the communications network to the server 102. The server 102, in step 338, receives the second user communication request data and determines with the processor which of the first user records or third user records should receive the second user communication request data. The second user communication request data includes at least one of (1) a second user offer to the first user, (2) a second user request to the second user to the third user for at least one of the third user's goods and the third user's services, and (3) a second user request to the third user to join a third user waiting list for at least one of the third user's goods and the third user's services. The second user communication request data may also include information configured to display a graphical notification on at least one of the selected first user's computing device and/or selected third user's computing device having the request of the second user, offer of the second user, or a responsive communication, such as text message or graphical responsive indicator. To determine which of the first user's or third user that will receive the second user communication request data, the second user communication request data may include embedded information corresponding to either the first user record or the third user record, such as first user identifying information or third user identifying information. The server 102, then sends, with the transceiver, in step 340, the second user communication request data via data packet 202, over the communications network, to the corresponding computing device, first user computing device 110 and/or third user computing device 118. The first user computing device 110 may receive the second user communication request data, in data packet 206, which may be configured for providing a graphical interface, or notification, to enable the first user to engage or interact with the second user via the second user request using the first communication tool. Any such responsive communication by the first user on the first user computing device is sent with the transceiver of the first user computing device to the server 102, over the communications network, which is then correspondingly sent to the second user computing device of which the second user communication request data originated. The communication data between the first user and the second user over the communications network is consistent with steps 320 through 324 corresponding to each respective computing device and its corresponding data packets. Similarly, the third user computing device 118 may receive the second user communication request data, in data packet 214, which may be configured for providing a graphical interface, or notification, to enable the third user to engage or interact with the second user via the second user request using the third communication tool. Any such responsive communication by the third user on the third user computing device is sent with the transceiver of the third user computing device to the server 102, over the communications network, which is then correspondingly sent to the second user computing device of which the second user communication request data originated. The communication data between the third user and the second user over the communications network is consistent with steps 352 through 356 corresponding to each respective computing device and its corresponding data packets.

In certain embodiments, the system may include a plurality of third users each having a third user computing device. In such embodiments, the system, at step 342, sends with the transceiver over the communications network to the third user computing device associated with one of the pluralities of third users, third user interface data in data packet 202, which is received as data packet 214. Data packet 214, includes the third user interface data for providing a third user interface. The third user interface is configured for receiving third user search parameters input from the third user computing device. The third user interacts with, or provides commands to, the third user computing device to input third user search parameters. The third user search parameters may include certain parameters of the second user record. The parameters may for example, include a predetermined geographic area, such as a zip code or radius from the third user's geographic location; the goods and or services of the second user; etc. The third user search parameters are configured to be sent over the communications network to the server for the server to be able to identify a stored second user record, retrieve said second user record, and display said second user record on the third user computing device. Other third user search parameters configured to engage the server to retrieve at least one of a corresponding second user record are within the sprit and scope of the disclosure. In step 344, the third user search parameters, data packet 216, are received over the communications network 106 with the transceiver which is then stored as data packet 204 in the connected database, specifically, the third user search parameters are stored in the corresponding third user record of which the data packet 216 originated. The server may access a previously stored data packet 204 having the third user data and third user record.

Following step 344, step 346 includes determining with the processor or server 102, based on the plurality of second user records which are stored in the connected database, which of the second user records satisfies the third user search parameters. The system may perform a series of algorithms to compare the data of the first user search parameters to the second user data having the second user record. In this step, the server may access a previously stored record 204 in the database 104. The system may then send with the transceiver, in step 348, data packet 202 having first user graphical display data, transmitted to the third user computing device as data packet 214. The third user graphical display data is configured for displaying a third user graphical display on the third user computing device. The third user graphical display (further detailed in FIG. 12A through 12B) includes a third map and the second user graphical indicator that corresponds to each of the plurality of second user records that satisfy the third user search parameters. If the system determines that there are no matching second user records that satisfy the third user search parameters, then the first user graphical display data may include notification data which may engage the third user interface to display a notification prompting the third user to refine the first user search parameters, of which the system will revert to step 342. Otherwise, when the system determines that there is at least one second user record that satisfies the third user searching parameters, then the third user graphical display data will provide for the second user graphical indicator to be disposed on the map of the third user graphical display corresponding the second user geographic location as indicated within the second user record. The second user graphical indicator may include displaying the second user record and a second user rating.

In step 350, the system, receiving with the transceiver, over the communications network from the third user computing device as data packet 216, selected second user data. The selected second user data is triggered by a gesture received on the third user graphical display proximate to the second user graphical indicator displayed on the third user computing device. The gesture may include computer gestures such as a tap, via a touch sensitive interface display, a click, on or near one of the second user graphical indicators. Where the gesture is performed on the first user graphical display having a plurality of second user graphical indicators, the closest second user graphical indicator in proximity to the gesture will be selected and stored on data packet 216 to be sent over the communications network and received by the server 102 and stored as data packet 204 in the connected database.

In step 352, a third communication tool is sent in data packet 202 by the server 102, across the communications network 106, to the third user computing device 118, which is received in data packet 214. The third communication tool is configured such that the third user interacts with, or provides commands to, or inputs a request or message on the third user computing device to communicate with the second user on the second user computing device. Once the request or message is input on the third user computing device, the third user communication request data, in data packet 216, is sent with the transceiver of the third user computing device, over the communications network to the server 102. The server 102, in step 354, receives the third user communication request data and determines with the processor which of the second user records should receive the third user communication request data. The third user communication request data includes a third user offer to the second user. The third user communication request data may also include information configured to display a graphical notification on the selected second user's computing device having the request of the third user, offer of the third user, or a responsive communication, such as text message or graphical responsive indicator. To determine which of the second users will receive the third user communication request data, the third user communication request data may include embedded information corresponding to the second user record, such as second user identifying information. The server 102, then sends, with the transceiver, in step 356, third user communication request data via data packet 202, over the communications network, to the corresponding second user computing device 114. The second user computing device 114 receives the first user communication request data, in data packet 210, which may be configured for providing a graphical interface, or notification, to enable the second user to engage or interact with the third user via the third user request using the second communication tool. Any such responsive communication by the second user on the second user computing device is sent with the transceiver of the second user computing device to the server 102, over the communications network, which is then correspondingly sent to the first user computing device of which the first user communication request data originated. The communication data between the second user and the third user over the communications network is also consistent with steps 336 through 340 corresponding to each respective computing device and its corresponding data packets.

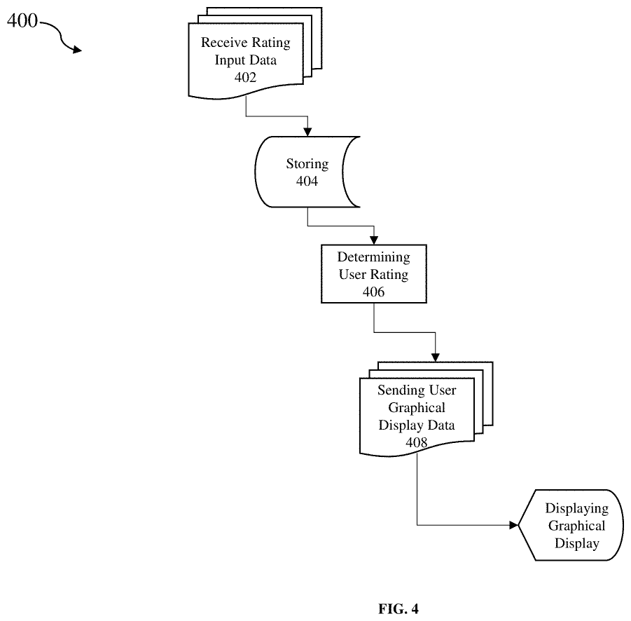

With reference now to FIG. 4, in certain embodiments, the process of FIG. 3 may further include the processes and steps disclosed in FIG. 4, according to an example embodiment. In step 402, the server 102 may receive with the transceiver over the communications network 106, second user rating input data, data packet 206, from a first user computing device 110. The second user rating input data corresponds to the selected second user and may include, consistent with this disclosure, embedded second user identifying information such that the server can determine which of the second user records corresponds to the second user rating input data. The second user rating input data may include information configured to display the second user rating on a user computing device. The second user rating input data may include customer reviews input from the first user or other users. The customer reviews may include a text description of the respective user's experience with the second user, images relating to the second user, and a rating of the second user. The second user rating may include a numerical rating, such as a rating on a scale of 1 through 10, or a pictorial rating for example, such as an indication of stars of 1 star to 5 stars. Stated differently, the second user rating is the rating or score that other user have given the second user based on the performance or metric of the second user. The minimum second rating may be the minimum rating of another user is willing or wants to search for. In step 404, the server 102 will store the second user rating input data, now data packet 204, in the connected database within the corresponding second user record. In this step, the server may access previously stored data packets 204 having second user data corresponding to second user records. In embodiments with a plurality of first user's and a plurality of first computing devices, the server may receiver over the communications network, a plurality of second user rating input data. The server, then in step 406, determines with the processor, the second user rating of the selected second user. The second user rating is calculated by an average of the plurality of second user rating input data. In step 408, the server 102 sends with the transceiver over the communications network, data packet 202 to the first user computing device 110, first user graphical display data. The first user computing device receives, with the transceiver, the first user graphical display data as data packet 206. The first user graphical display data is configured for displaying the first user graphical display having the second user graphical indicator that corresponds to the selected second user where the second user graphical indicator has the second user rating. One inventive feature is that the current embodiments are able to display, in the graphical displays, the search results of the user such that it is easier For the users to identify which of the second users the first users would like to select.

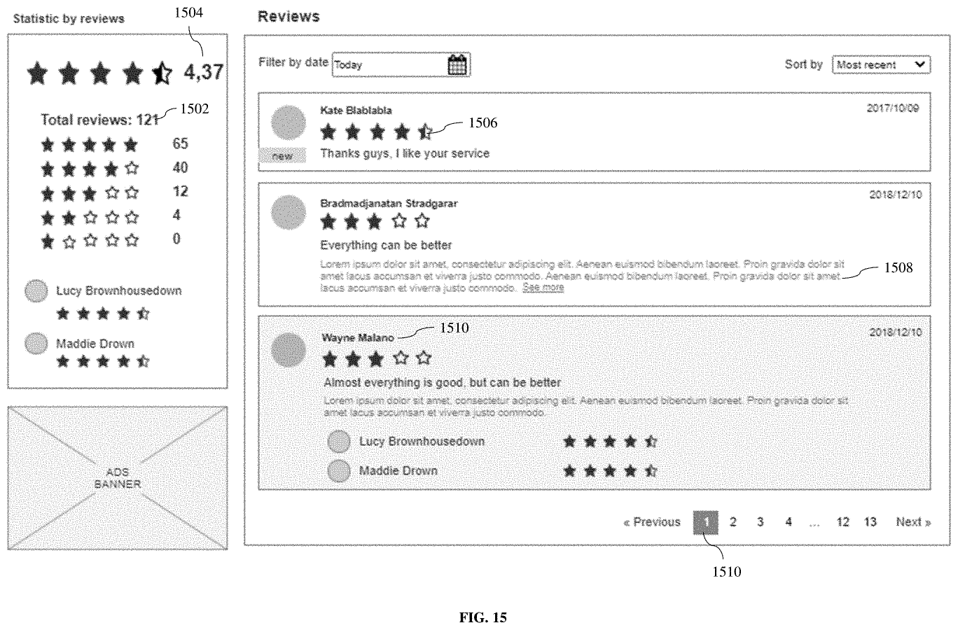

With reference to FIGS. 4 and 15, FIG. 15 illustrates an example graphical display of graphical display data having the user rating as determined from the user rating input data as described by the methods of FIG. 4. In the example shown, the system computed an average of 121 second user rating input data 1502 to generate the second user rating 1504. The second user rating input data may include a second user rating as indicated by an icon 1506 which is shown as a star. Each star may correlate to a numerical value, for example, 1 star may correlate to the numerical value “1”, and two and a half stars may correlate to the numerical value “2.5”. Each of the plurality of second user rating input data may include a different second user rating of which the system computes an average of the second user rating input data to define the overall second user rating 1504. The second user rating 1504 may be shown numerically, as depicted as a 4.37 rating, or graphically, shown as approximately 4.5 stars. Additionally, the second user rating input data may include a text field to allow the user to manually enter comments and reviews based upon the users experience with the second user. Each of the second user rating input data may be graphically displayed to allow other users to view the experience and information with the second user. The second user rating input data may include the personal identifying information 1510 of the user, such as the name, of which the second user rating input data originated. Additionally, a date may be displayed that correlates to the time and day that the second user rating input data was sent across the communications network.

In other embodiments, the system may execute steps 402 through 408 where in step 402, the server 102 receives the second user rating input data from the third user computing device. In step 402, the server 102 may receive with the transceiver over the communications network 106, the second user rating input data, data packet 216, from a third user computing device 110. The second user rating input data corresponds to the selected second user and may include, consistent with this disclose, embedded second user identifying information such that the server can determine which of the second user records corresponds to the second user rating input data. The second user rating input data may include information configured to display the second user rating on a user computing device. The second user rating input data may include customer reviews input from the third user. The customer reviews may include a text description of the respective user's experience with the second user, images relating to the second user, and a rating of the second user. The second user rating may include a numerical rating, such as a rating on a scale of 1 through 10, or a pictorial rating for example, such as an indication of stars of 1 star to 5 stars. In step 404, the server 102 will store the second user rating input data, now data packet 204, in the connected database within the corresponding second user record. In this step, the server may access previously stored data packets 204 having second user data corresponding to second user records. In embodiments with a plurality of third user's and a plurality of third user computing devices, the server may receiver over the communications network, a plurality of second user rating input data. The server, then in step 406, determines with the processor, the second user rating of the selected second user. The second user rating is calculated by an average of the plurality of second user rating input data. In step 408, the server 102 sends with the transceiver over the communications network, data packet 202 to the third user computing device 110, third user graphical display data. The third user computing device receives, with the transceiver, the third user graphical display data as data packet 214. The third user graphical display data is configured for displaying the third user graphical display having the second user graphical indicator that corresponds to the selected second user where the second user graphical indicator has the second user rating.

In other embodiments, the second user rating may be calculated by an average of each of the plurality of second user input data received by the server from the first user computing devices and the second user computing devices. Furthermore, in certain embodiments, steps 402 through 408 may include the server receiving first user rating input data and third user rating input data from a second user computing device. In step 402, the server 102 may receive with the transceiver over the communications network 106, at least one of first user rating input data and third user rating input data, as data packet 212, from a second user computing device 114. The first user rating input data corresponds to the selected first user and may include, consistent with this disclose, embedded first user identifying information such that the server can determine which of the first user records corresponds to the first user rating input data. The first user rating input data may include information configured to display the first user rating on a user computing device. The first user rating input data may include reviews input from the second user. The reviews may include a text description of the second user's experience with the first user, images relating to the first user, and a rating of the first user. The first user rating may include a numerical rating, such as a rating on a scale of 1 through 10, or a pictorial rating for example, such as an indication of stars of 1 star to 5 stars. Likewise, the third user rating input data corresponds to the selected third user and may include, consistent with this disclose, embedded third user identifying information such that the server can determine which of the third user records corresponds to the third user rating input data. The third user rating input data may include information configured to display the third user rating on a user computing device. The third user rating input data may include reviews input from the second user. The reviews may include a text description of the second user's experience with the third user, images relating to the third user, and a rating of the third user. The third user rating may include a numerical rating, such as a rating on a scale of 1 through 10, or a pictorial rating for example, such as an indication of stars of 1 star to 5 stars. In step 404, the server 102 will store the first user rating input data and/or the third user rating input data, now data packet 204, in the connected database within the corresponding the respective first user record and/or third user record. In this step, the server may access previously stored data packets 204 having first user data corresponding to first user records or third user data corresponding to third user records. In embodiments with a plurality of second user's and a plurality of second user computing devices, the server may receiver over the communications network, a plurality of first user rating input data and/or a plurality of first user rating input data. The server, then in step 406, determines with the processor, the first user rating of the selected first user by calculating an average of the plurality of first user rating input data. A third user rating may also be determined by the processor by calculating an average of the plurality of third user rating input data. In step 408, the server 102 sends with the transceiver over the communications network, data packet 202 to the second user computing device 114, second user graphical display data. The second user computing device receives, with the transceiver, the second user graphical display data as data packet 210. The second user graphical display data is configured for displaying the second user graphical display having at least one of the first user graphical indicator that corresponds to the selected first user where the first user graphical indicator has the first user rating, and the third user graphical indicator that corresponds to the selected third user where the first user graphical indicator has the first user rating.

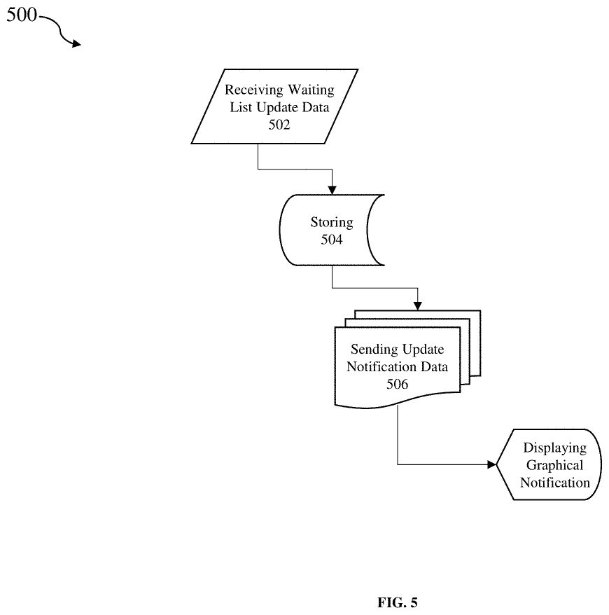

With reference now to FIG. 5, in certain embodiments, the process of FIG. 3 may further include the processes and steps disclosed in FIG. 5, according to an example embodiment. In step 502, the server 102 receives with the transceiver, over the communications network 106 from the second user computing device 114, second user waiting list update data. The second user waiting list update data is sent from the second user computing device as data packet 212. The second user waiting list update data corresponding to changes to the second user waiting list and includes information configured to display a graphical representation of at least one of a wait list and/or a notification indicating the current first user position on said waiting list. For example, the waiting list may include the names of a plurality of first user seeking the services offered by the second user. When each of the first user's is moved off of the waiting list because either (1) the first user received the second user's services, or (2) the first user is no longer interested in the second user's services; then the remaining first user's on the waiting list will change spots on the waiting list, such that each of the first users is assigned a corresponding number on the waiting list and each first user's corresponding number is changed when a first user is removed from the waiting list. The waiting list update data may include personal identifying information about the first users on the waiting list, generally, the name of the first users, or in other embodiments to protect the identity of other first users on the waiting list, a pseudo name or anonymous indicator of the other users on the waiting list. In other embodiments, the other first users' identifying information is not displayed on the waiting list. In step 504, the system stores the second user waiting list update data in the corresponding second user record in the connected database as stored record 204. The server 102 may access previously stored records 204. The system then determines, based on the second user waiting list update data, which of the corresponding first user records to send update notification data to. The second user waiting list update notification data may include a plurality of first user identifying information, such as a first user name for example and send the update data notification to each of the plurality of first users on the second user waiting list. The server 102, in step 506, sends with the transceiver, over the communications network 106 to the first user computing device 110, the update notification data, in data packet 202, which is received by the first user computing device as data packet 206 or by a plurality of first user computing devices operated by a plurality of first users on the second user waiting list. The update notification data is configured for displaying a graphical update notification on the first user interface that includes the second user waiting list update data from data packet 212. The update notification data may include information for displaying a graphical notification indicating the current first user position or status may read as, for example, “you are currently 5th on the waiting list” whereas an update may read, for example, “you are now forth on the waiting list for the second user's”. Other messages and notifications configured to update the first user on the first user interface are within the spirit and scope of the disclosure. The update notification data may include the current waiting list status of each respective first user on the second user waiting list. The sever may send in data packet 202, the information for displaying the graphical notification on each of the first user's computing devices of which the first user is on the waiting list. Each notification received by the first user may include a separate message indicating that respective user's status or position on the second user waiting list. In certain embodiments, the server may read the stored first user record and access the first user identifying information, generally, the first user contact information including phone number and email address for example. The server may then send across the communication network to the first user computing device the update notification data. The data packet 202 may be configured to send the first user an email or a cellular text message to be displayed on the first user computing device such that the notification contains the update notification data.

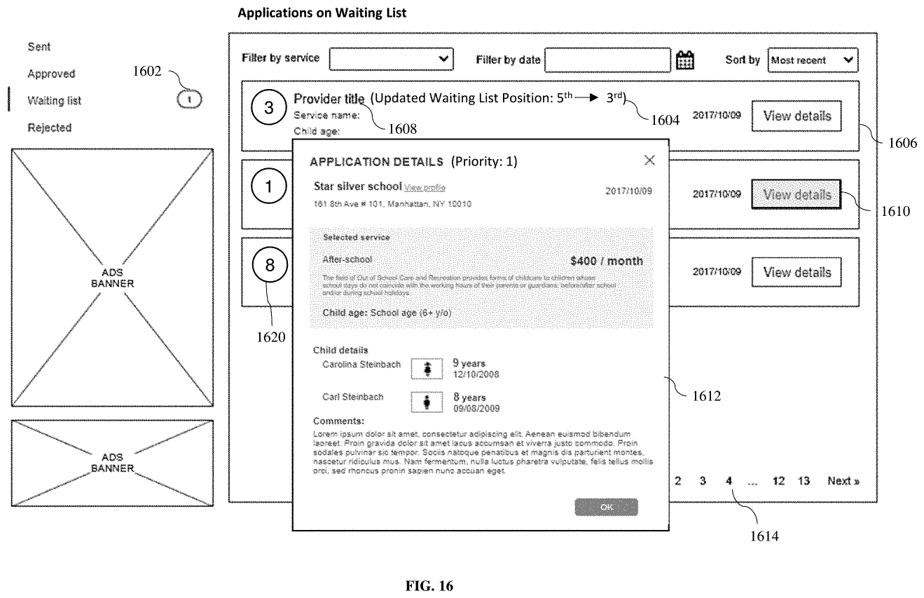

With reference to FIGS. 5 and 16, FIG. 16 illustrates an example display of the methods disclosed in FIG. 5. The waiting list display may include a variety of user interface elements configured to allow the user to interact with the display. The wait list display update data is data that is updated or changed by the second user. The second user may input, alter, or change the order and/or priority of the first users on the waiting list. As such the waiting list display may include user interface elements, such as a button or click and drag, to edit the order of the waiting list. Any changes made to the waiting list will define the waiting list update data which will be sent across the communications network to the plurality of first users on the waiting list. The waiting list update data may include information for displaying the embodiment of FIG. 16. The waiting list update data may include graphical notifications 1602 and 1604 for example. Also, the waiting list update data may be sent via push notifications or email, for example, to each of the first users on the second user waiting list depending on the provided first user data and the first user identifying information of the first user record. Graphical notification 1602 may be an aggregated total of the notifications of 1604. In other terms, if the first user receives a notification update 1604 from multiple second users, 3 for example, then the graphical notification 1602 may display a number “3” indicating the total number of notifications. In other embodiments, this number may be an aggregate of the total number notifications 1604 that the first user has not read or interacted with since the first user computing device received the update notification data. The update notification data may also display a wait list having the different applications that the first user submitted to each of the second users for their services. The second user waitlists a first user when the second user has no available openings left for a service or program and has accepted the first user's application. The second user will go through the waitlist and remove the first user from the top position of the waitlist, which is indicated by the number 1, when an opening is available. The update notification data may indicate each of the applications 1606 and display second user identifying information 1608 associated with the second user that received the application. Each of the applications may include a priority number 1620 indicating the waiting list position of the first user. The priority number allows the first user to quickly identify their position in the second user's waiting list such that the first user may be prepared. Furthermore, the user may interact with the interface, by clicking on a button 1610 for example, to review the details 1612 of the application. The application details 1612 may display the second user record, the first user search parameters, the first user child information, the second user price, the second user geographical location, and other details of the first user and/or the second user relating to the application. The first user may interact with different pagination tools 1614 to filter through a plurality of applications 1606.

In other embodiments, in step 502, the server 102 receives with the transceiver, over the communications network 106 from the third user computing device 118, third user waiting list update data. The third user waiting list update data is sent from the third user computing device as data packet 216. The third user waiting list update data corresponding to changes to the third user waiting list and includes information configured to display a graphical representation of at least one of a waiting list and/or a notification indicating the current second user position on said waiting list. For example, the waiting list may include the names of a plurality of second user seeking the services offered by the third user. When each of the second user's is moved off of the waiting list because either (1) the second user received the third user's services, or (2) the second user is no longer interested in the third user's services; then the remaining second user's on the waiting list will change spots on the waiting list, such that each of the second users is assigned a corresponding number on the waiting list and each second user's corresponding number is changed when a second user is removed from the waiting list. The waiting list update data may include personal identifying information about the second users on the waiting list, generally, the name of the second users, or in other embodiments to protect the identity of other second users on the waiting list, a pseudo name or anonymous indicator of the other users on the waiting list. In other embodiments, the other second users' identifying information is not displayed on the waiting list. In step 504, the system stores the third user waiting list update data in the corresponding third user record in the connected database as stored record 204. The server 102 may access previously stored records 204. The system then determines, based on the third user waiting list update data, which of the corresponding second user records to send update notification data to. The third user waiting list update notification data may include a plurality of second user identifying information, such as a second username for example and send the update data notification to each of the plurality of second users on the third user waiting list. The server 102, in step 506, sends with the transceiver, over the communications network 106 to the second user computing device 114, the update notification data, in data packet 202, which is received by the second user computing device as data packet 210 or by a plurality of second user computing devices operated by a plurality of second users on the third user waiting list. The update notification data is configured for displaying a graphical update notification on the second user interface that includes the third user waiting list update data from data packet 216. The update notification data may include information for displaying a graphical notification indicating the current first user position or status may read as, for example, “you are currently 5th on the waiting list” whereas an update may read, for example, “you are now forth on the waiting list for the second user's”. Other messages and notifications configured to update the second user on the second user interface are within the spirit and scope of the disclosure. The update notification data may include the current waiting list status of each respective second user on the third user waiting list. The sever may send in data packet 202, the information for displaying the graphical notification on each of the second user's computing devices of which the second user is on the waiting list. Each notification received by the second user may include a separate message indicating that respective user's status or position on the third user waiting list.

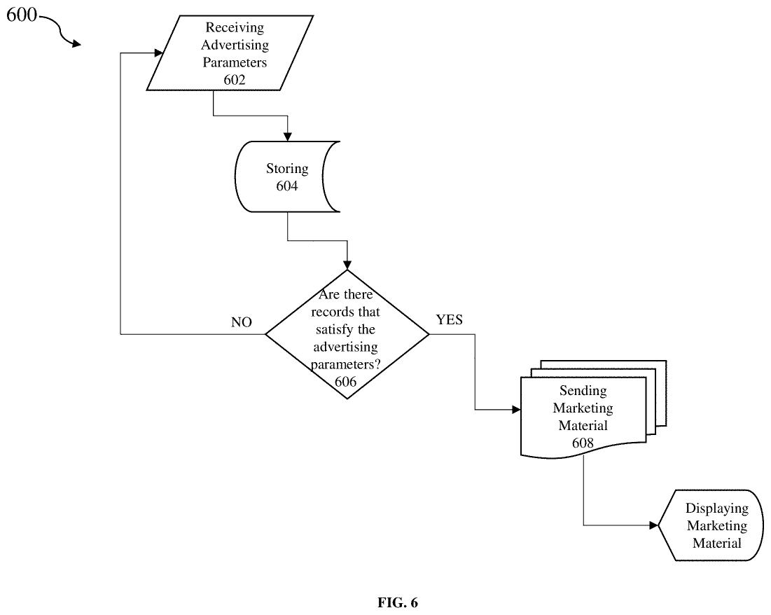

With reference now to FIG. 6, in certain embodiments, the process of FIG. 3 may further include the processes and steps disclosed in FIG. 6, according to an example embodiment. In step 602, the system receives with the transceiver, over the communications network 106 from one of a plurality of the second user computing devices 114, advertising parameters, data packet 212. The advertising parameters may include the first user child information, such as the age and gender of the child; the first user geographic location; and other information contained within the first user record. The advertising parameters may be input on the second user computing device consistent with this disclosure. The server 102 then stores, in step 604, the advertising parameters in the corresponding second user record in the connected database as stored record 204. The server 102 may access previously stored records 204 having second user data for the second user records. Then in step 606, the system determines with the processor, based on at least one of a plurality of first user records and the plurality of third user records, which of the first user records and the third user records satisfy the advertising parameters. The corresponding first users and third users of the first user records and third user records that satisfy the advertising parameters may be defined as a targeted user. The server 102 may access previously stored records 204 having the first user data of the plurality of first user records and the third user data of the plurality of third user records. Then, in step 608, the server 102 send with the transceiver, over the communications network 106 to a targeted user computing device of the targeted user, marketing material from the second user. The targeted user computing device may include the first user computing device 110 and the third user computing device 118 that correspond to each of the first user records and second user records that satisfied the advertising parameters. The marketing material may include brochures, flyers, postcards, business cards, sales sheets, pictures, informative messages, and other material containing offers of services, promotions, discounts, information about services and experiences, etc. This process, in accordance with the principles of the disclosed embodiments, may give rise to various revenue-generating arrangements. The second user 112 may, for example, pay fees to the operators of server 102 in exchange for the services provided by server 102, i.e., the provision of advertisements and marketing materials to the first computing device 110 of the first users 108 and/or the third user computing device 118 of the third user 116 that correspond to the advertising parameters of data packet 212 transmitted from the second user computing device over the communications network 106 to the server 102. The advertising parameters will be stored records 204 of the second user record that the data packet 212 originated such that the second user may pay additional fees for the sever to repeatedly engage process step 606 through 608 to send the marketing and advertising material to the other users.

Such revenue generating arrangements may define second users that pay fees for advertisements as premium second users. Premium second users are those who maintain paid, premium listings, advertisements, and marketing material with the system and its operators. The system further includes a premium user verification system such that the premium second users are required to verify and/or update their listing information on a monthly basis. The server 102 may send in data packet 202 across the communications network, automated trigger emails to be displayed on the second user computing device of the premium second user. To send the automated trigger emails, the server may access the stored record of the premium second user and read the second user identifying information to access the contact information of the second user. Because the quality and accuracy of information is critical to the operation of the system, the second users' premium listings will be disabled if three attempts by the system to verify the listing information have been ignored. The server will send each request to verify information after a predetermined time period, such as one week for example, to obtain the information from the second user. The verification information may, for example, information stored within the second user record such as availability, second user identifying information, second user contact information, second user licenses, second user services, second user hours of operation, second user price, etc.

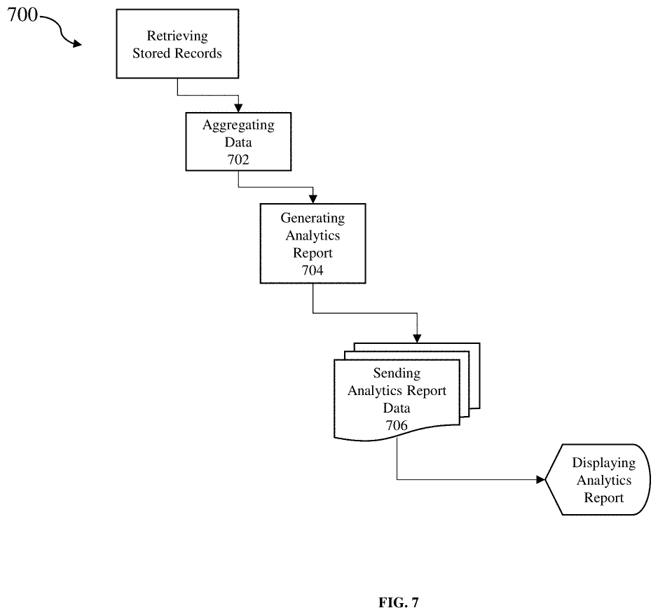

With reference now to FIG. 7, in certain embodiments, the process of FIG. 3 may further include the processes and steps disclosed in FIG. 5, according to an example embodiment. In step 702, the system may aggregate with the processor, searching data and at least one of: (1) the plurality of first user records, (2) the plurality of second user records, and (3) the plurality of third user records to generate aggregate data. The searching data may include the first user search parameters, the second user search parameters, third user search parameters, results of the first user search parameters, results of the second user search parameters, results of the third user search parameters, number of times each user was selected, aggregate personal identifying information of the user records including, for example, most common child age and most active geolocation collectively for the first users, second users, and third users. The aggregate data may be based on a computation of the searching data and include graphical representations, such as spreadsheets, charts, graphs, pictorials, etc. of the searching data. In certain embodiments, the user seeking to generate aggregate data may select the searching data that they would like to aggregate into the analytics report. Additionally, the aggregate data may include information for generating an analytics report and displaying the analytics report on the user interface of a user computing device. In step 704, the server with the processor may generate an analytics report. The analytics report may include displaying the aggregate data on a user-friendly graphical interface configured for interpreting the searching data. Then in step 706, the server 106 sends with the transceiver in data packet 202, over the communications network 106 to the second user computing device 114, analytics report data for displaying on the second user interface an analytics report having an aggregated graphical representation of the aggregate data. The analytics report data is received by the second user computing device as data packet 210. The analytics report data may include the aggregated graphical representations of the aggregate data and the searching data as depicted by charts, graphs, spreadsheets, and other embodiments to display and communicate computations of aggregated information.

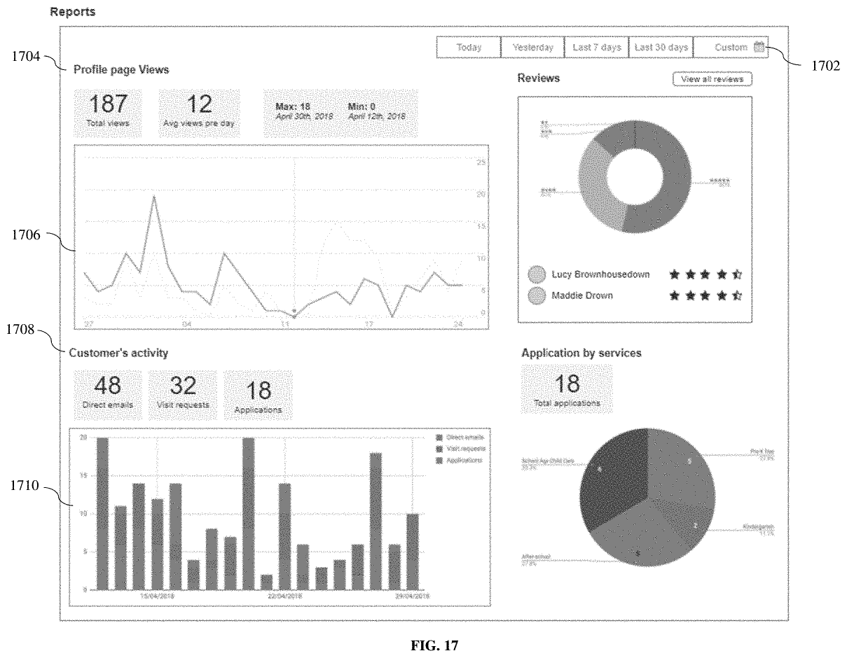

With reference to FIGS. 7 and 17, FIG. 17 illustrates an example graphical display of an analytics report as produced by the methods of FIG. 7. The aggregated data may be compiled over a predetermined period of time or by selecting certain user records of the searching data to aggregate. As illustrated, the analytics report may display a time selection tool 1702 configured for allowing the user to alter the time period of stored records of the searching data, only aggregating the results retrieved within the said time period. Furthermore, the analytics report may include aggregated graphical representations of different searching data. For example, searching data 1704 is depicted as total profile views (as a selected second user) of the second users record which may include aggregated data of a plurality of first users records, second user records, and third user records that selected the second user. The aggregate data of searching data 1704 is displayed using the aggregated graphical representation 1706, which is illustrated as a line graph. Likewise, searching data 1708 includes only the first user activity and the first user records of which the corresponding aggregated graphical representation 1710 displays the results in a bar chart, for example. Other charts, graphs, and illustrations configured to display the aggregate data for the user are within the spirit and scope of the disclosure. The aggregated data may include compilations of any information stored within each of the user records, include for example, application data by services, aggregated child information of the first users, geolocation data, most sought after goods and services, most sought working hours and/or hours of operation, most search parameters, and any other information stored within the connected database.

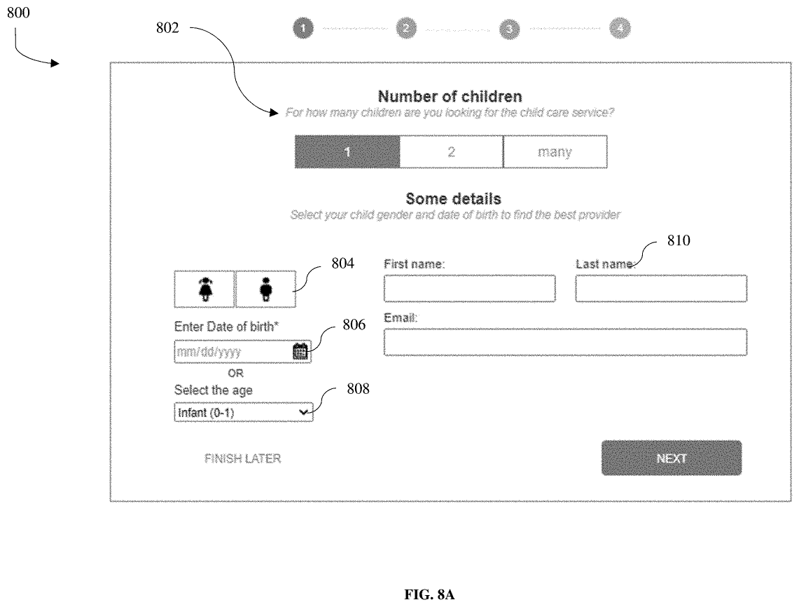

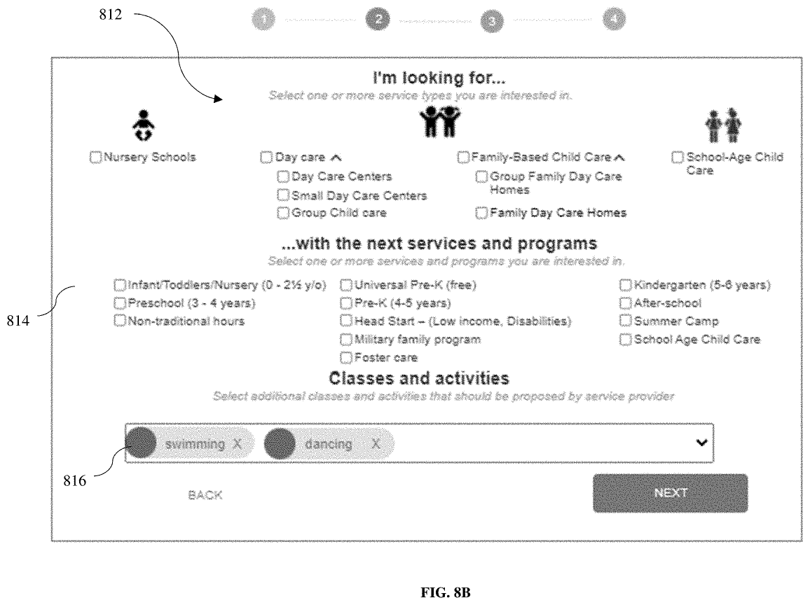

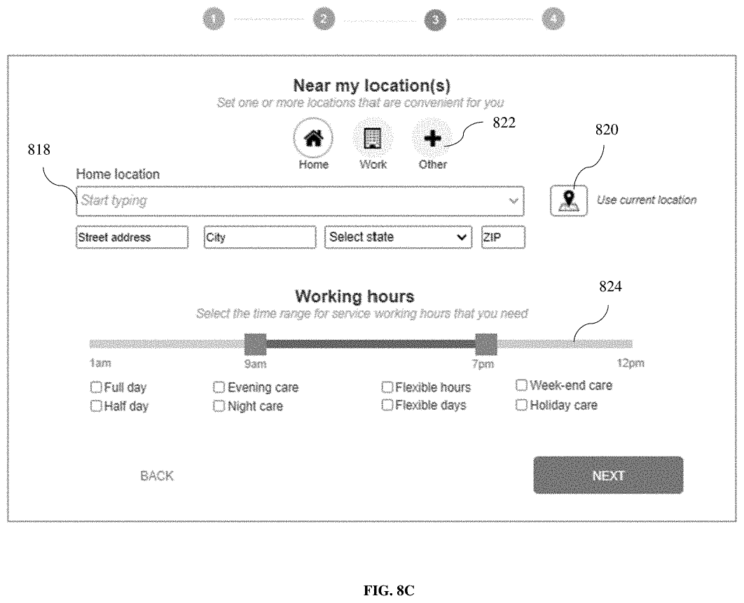

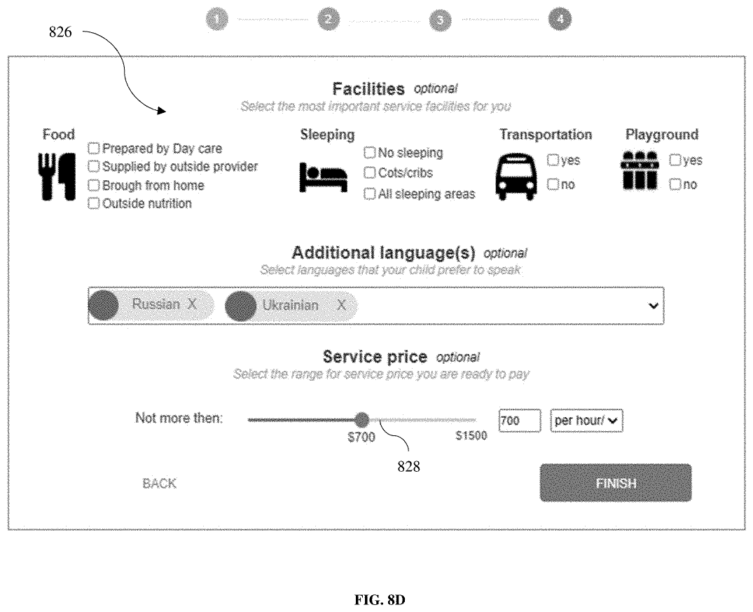

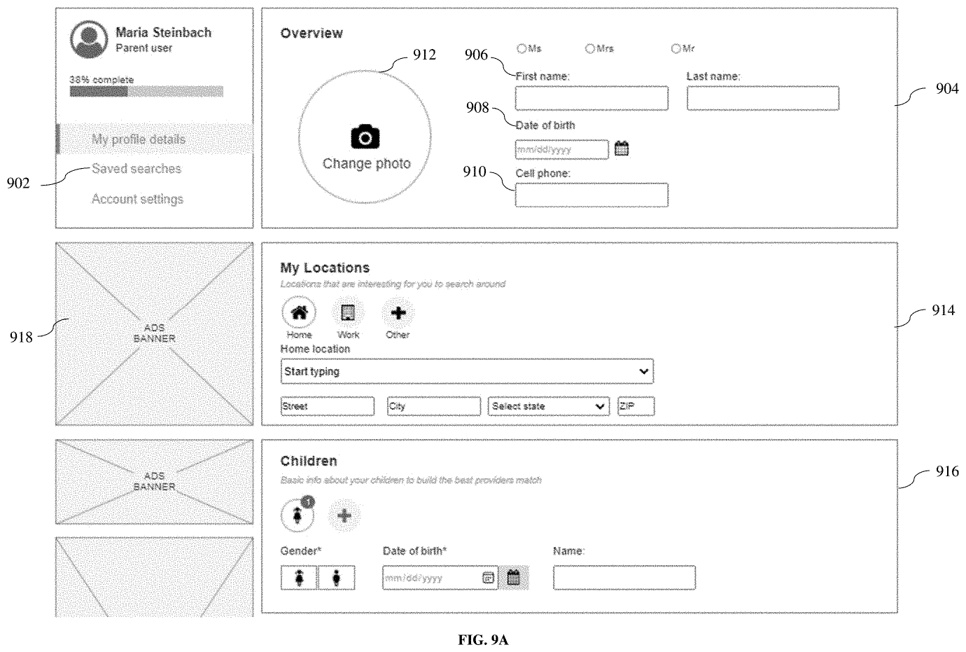

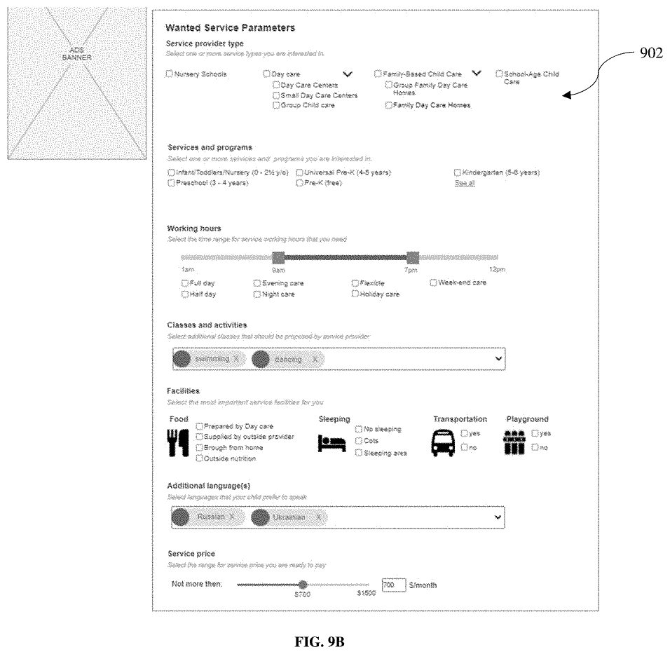

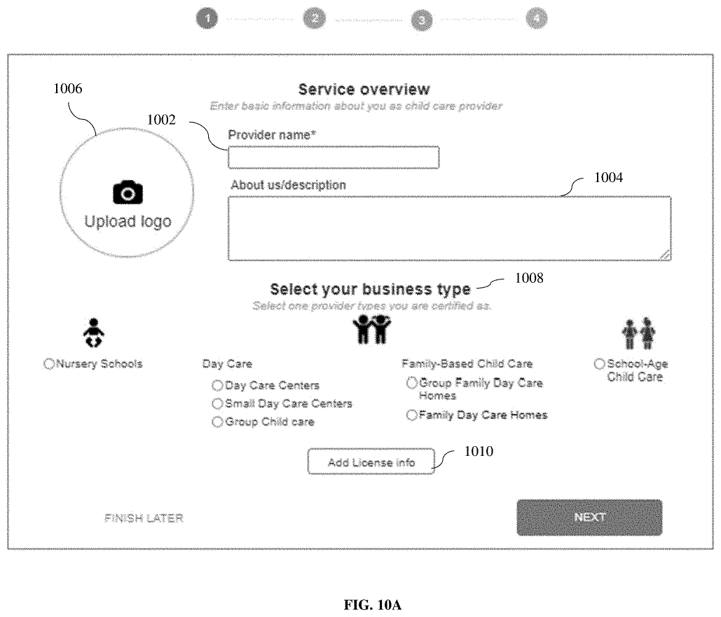

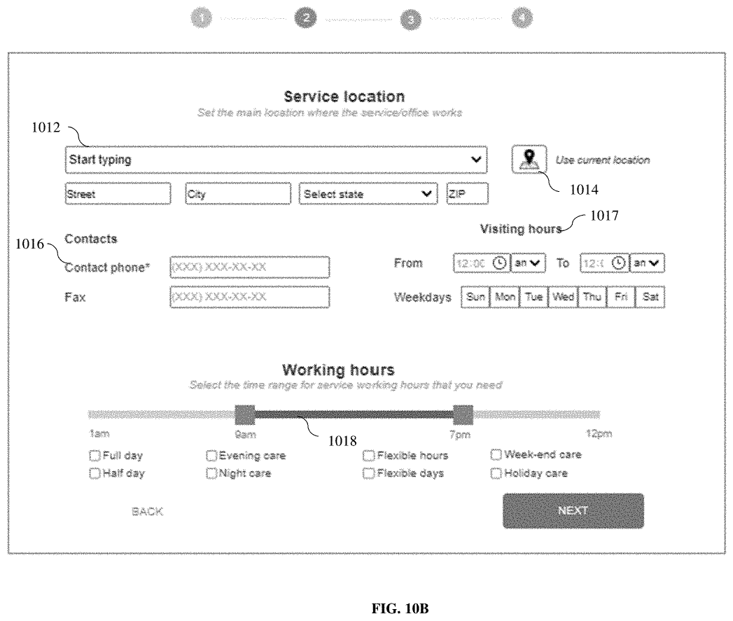

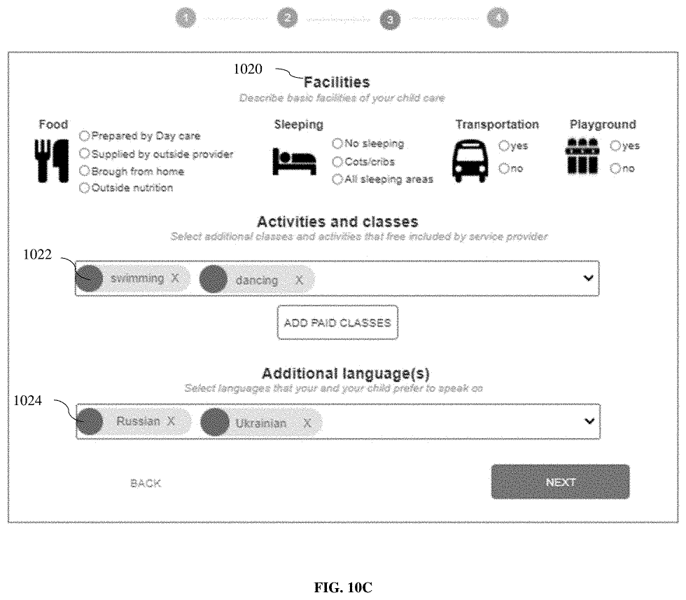

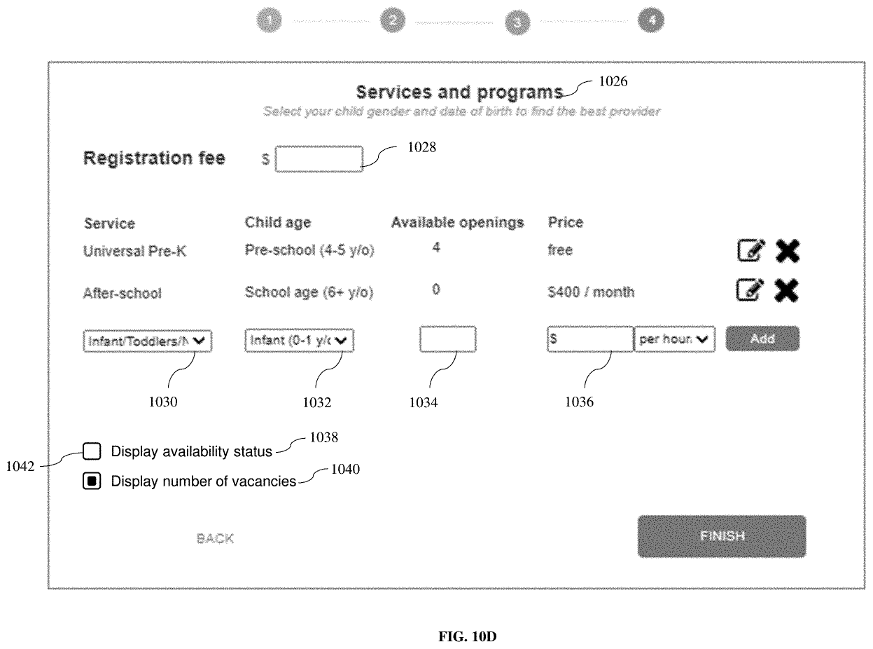

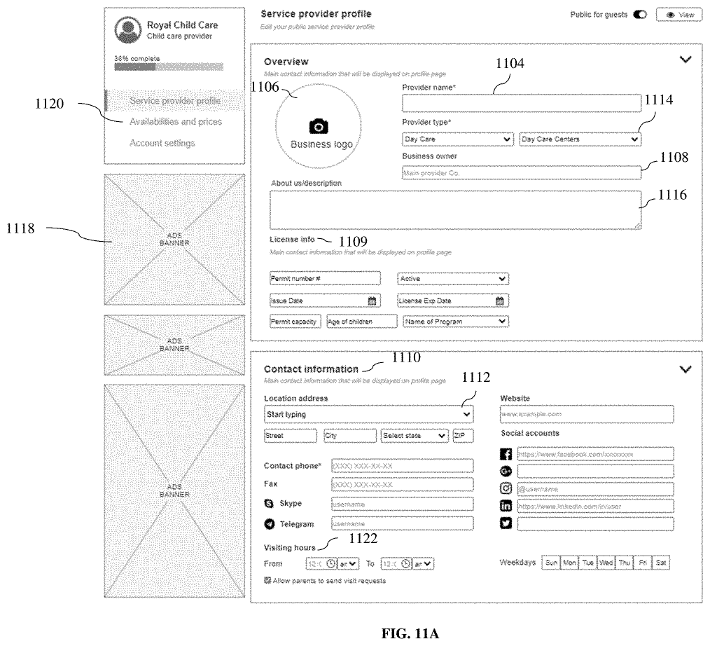

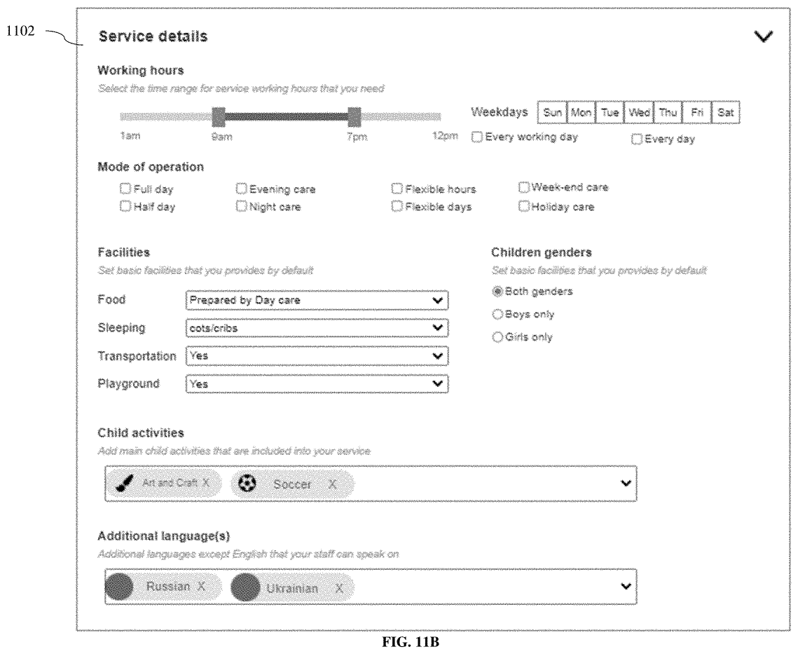

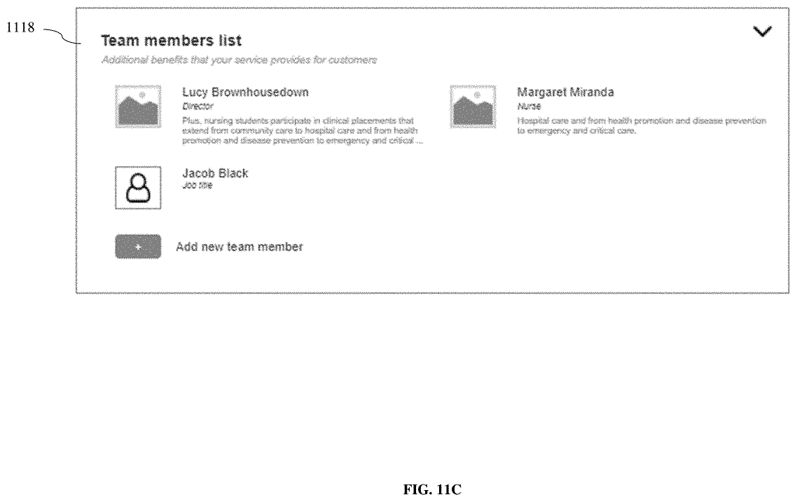

With reference now to FIGS. 8A through 11C, an example user interface is shown. With regards to FIGS. 8A through 8D, an example first user interface that may be displayed on a first user computing device is shown. FIGS. 9A and 9B are example graphical displays of the stored first user record of which may appear on a computing device. Similarly, FIGS. 10A through 10D are example second or third user interfaces which may be displayed on a second user computing device or third user computing device respectively. Likewise, FIGS. 11A through 11C depict the graphical representation of the stored record which may be for each of the second user records or third user records, depending on the embodiment and the users interacting with the system. Generally, the embodiments disclosed herein may be sent by the server across the communications network to the computing devices to provide a user interface configured to allow the user to input information. With reference to FIG. 2, in one embodiment, the interfaces of FIGS. 8A through 8D and 10A through 10D may be sent as data in data packet 202 across the communications network, of which the first user may receive in data packet 206 the data correlating to displaying the embodiments of FIGS. 8A through 8D on the first user computing device and the second user may receive in data packet 210, or the third user in data packet 214, the data correlating to displaying the embodiments of FIGS. 10A through 10D on the second and third user computing devices, respectively. Each of the first user interface, first user graphical display, second user interface, second user graphical display, third user interface and graphical display may be configured to allow the user to interact with the interface, and/or webpage, such that the interface(s) and display(s) may include a plurality of user interface elements such as input controls, navigation components, informational components, and containers. Such user interface elements may include for example, accordions, bento menu(s), breadcrumb(s), button(s), card(s), carousel(s), check box(es), comment(s), doner menu(s), dropdown(s), feed(s), form(s), hamburger menu(s), icon(s), input field(s), kebab menu(s), loader(s), meatball menu(s), modal(s), notification(s), pagination(s), picker(s), progress bar(s), radio button(s), search field(s), sidebar(s), slide control(s), stepper(s), tag(s), tab bar(s), tool tip(s), and toggle(s). Each of these user interface elements may be used in certain embodiments to enable each of the users to interact with the system, provide data to and from the server across the communications network and implement the methods as discussed in FIGS. 3A through 7. Other user interface elements configured to provide a display to the user to interact with the system in accordance with the methods described herein may be used and are within the spirit and scope of the disclosure.

Referring now specifically to FIGS. 8A through 8D, the embodiments may be sent as first user interface data 800 in step 302 and/or step 310 to the first user computing device. When the interface data is sent in step 302, the data input on the user interface will define the first user data of which the server will generate the first user record and store said first user record. Where the interface data is sent in step 310, the data input on the user interface may define the first user search parameters of which the server will receive the search parameters and store the search parameters in the first user record. The first user data as shown in FIGS. 8A through 8D, is configured for providing a display for the first user to interact with such that the first user can enter the first user data or the first user search parameters. The first user data may include the first user identifying information, the first user geographic location; and the first user child information. The first user enters the first user child information which may include the number of children 802 associated with the first user of which the first user is the parent or legal guardian of said child. The child information may further include the gender or sexual identity of the child 804, for example, male or female; the child's birthday 806; and/or the age range 808 that the child falls into, such as ‘infant (0-1)’. In certain embodiments the user may interact with the interface to input the data by selecting a button, clicking on a provided option from a drop-down menu, or manually typing in the information. Per the example interface, the user may enter its identifying information 810, shown as the first name, last name, and email address of the user. Other embodiments may prompt the first user to input identifying information consistent with the spirit and scope of the disclosure.

The interface may further include prompting the first user to enter the services 812 of the provider that they seek, of which correlates to the second users. The interface may display user friendly icons to depict the age range that the type of services is oriented towards. For example, the services 812 have an icon of a baby disposed on the interface next to the nursery school so that the user can readily identify and make the selection of the services on the interface. Each icon may be a user interface element, such as a pop-up when user gestures, such as pans over or clicks on the icon, which will be configured to display a size or capacity of the service provider. Each of the services 812 will correspond to a certain number of children within the daycare, or in other terms, the size of the second user's facility or capacity of the childcare provider. For example, a day care center may be more than six children a small day care center may be up to six children. The number of children provided or cared for under the services is important to convey to the first user the quality of the provider-childcare relationship. For example, a smaller day care provider having up to 6 children may be more hands-on and interactive with the child as compared to a larger day care center having a large plurality of children to care for. That is not to say that the larger day care center does not offer its own benefits, for example, the large day care provider may have more child-to-child interactions for the child to develop more social skills among peers. This information is important to the first user, i.e., the parent, to determine the needs of the child, such as educational, learning, and social needs. As shown, the services may include, but are not limited to, nursery schools, day care, family-based childcare, and school aged childcare. Additionally, the user may select an age range 814 of which the services are provided for. The age range 814 of the services will correspond to the second user services (further detailed in FIG. 10A). Likewise, the user may input classes and activities 816 that should be proposed by the service provider, i.e., the second user, for example swimming, dancing, or sports. Other classes and activities input by the user are within the spirit and scope of the disclosure. These selections and user inputs will be stored in the first user record as first user data and may be used to predefine the first user search parameters.

The first user may also be prompted to enter a first user geographic location 818. The first user may enter the desired address of the location, including the street address, city, state, and zip code. The first user may also click a button 820 to enable the system to engage the GPS or cellular location devices of the first user computing device to determine the first user's current location. Additionally, the first user data may be configured to include a plurality of first user geographic locations, each of which will be stored on the first user record and of which the user can filter on the first user search parameters which of the second user records are proximate to each location. For example, the system may store a first user geographic location corresponding to the first user's home, work, or other location 822 as desired and input by the first user. The interface may further include a slider, configured to allow the user to select a predetermined working hours 824, of which the user needs the childcare services of the second user. This input may correspond to the search parameters which may retrieve second user records having second user operating hours that correspond to the first user working hours. In other embodiments, the user may click on the hours needed, enter specific times of the day, or enter a total number of hours needed for the second user to care for the child.

In other embodiments, the interface may include optional inputs which allow the first user to enter in the first user data to be stored on the first user record such as specific requirements 826 of the facilities of the second user. The specific requirements may include food and dietary requirements such as food prepared by the second user, food supplied by an outside provider, food brought from home, and other nutrition; sleeping arrangements such as no sleeping or nap time in the second user facility, cots/cribs available for sleeping, other sleeping areas; transportation such as whether the first user needs to obtain transportation for the child to the second user facility or whether the second user provides transportation such as a bus stop/schedule; and playground access for the children. The first user may also desire specific languages to be spoken by the second user which may be input into the system. Additionally, the first user may interact with slider having a desired price range that they are willing to pay for the second user's services. The server may user these inputs, such as the price range, to retrieve stored second users which correspond to these search parameters.

With reference to FIGS. 9A through 9B, an example graphical representation of the stored first user record is shown. In this example embodiment, the stored record may only be accessible by the first user on the first user interface. When the first user accesses the stored record, the server may retrieve previously stored record 204, send data packet 202, which is sent to the first user computing device as data packet 206 which may contain the information for displaying the first user data and first user record on the first user computing device. The data packet 206 may allow the user to edit the first user record on the interface which may permanently alter stored record 204. This particular display on the first user computing device is a profile that only the first user can access. The first user may access the entirety of its stored record including the saved first user search parameters; the first user identifying information having for example the first user name 906, first user date of birth 908, first user cell phone 910, and first user profile picture 912; the first user geographic locations 914; and the first user child information 916. Additionally, on the first user interface, the data in data packet 206 may include displaying the marketing material 918 as described in FIG. 6. The marketing material may include advertisements, videos, pictures, prices, embedded links, and offers from or relating to the second user. If the first user is receiving the marketing material in data packet 206 that is displayed on the first user interface, then the first user record, which may include the saved first user search parameters, first user identifying information, first user geographic location, or first user child information, satisfies the advertising parameters of the second user.

Referring now specifically to FIGS. 10A through 10D, the embodiments may be sent as second user interface data 800 in step 302 and/or step 326 to the second user computing device. When the interface data is sent in step 302, the data input on the user interface will define the second user data of which the server will generate the second user record and store said second user record. Where the interface data is sent in step 326, the data input on the user interface may define the second user search parameters of which the server will receive the search parameters and store the search parameters in the second user record. The second user data as shown in FIGS. 10A through 10D, is configured for providing a display for the second user to interact with such that the second user can enter the second user data or the second user search parameters. The second user data may include the second user identifying information, the second user geographic location, second user services, the description of a second user facility, the second user price, and second user hours of operation. Similarly, when the embodiment defines a third user interface, the third user interface may include the third user identifying information, the third user geographic location, third user services, third user goods, third user hours, and third user price. In certain embodiments the user may interact with the interface to input the data by selecting a button, clicking on a provided option from a drop-down menu, or manually typing in the information.

Per the example interface in FIG. 10A, the user may enter its identifying information 1002, shown as the provider's name Other embodiments may prompt the second user to input identifying information consistent with the spirit and scope of the disclosure. The interface may further include prompting the second user to enter a description of the second user facility 1004 and an image of a logo 1006 of the second user's business, for example. The user may also select a second user service 1008, indicating the service type the user is certified as. The interface may display user friendly icons to graphically represent the business types per age group. For example, an icon of a baby is disposed next to the nursery school so that the user can readily identify and make the selection of the services on the interface. Each icon may be a user interface element, such as a pop-up when a user gestures, such as pans over or clicks on the icon, which will be configured to display a size or capacity of the service provider. Each of the services 1008 will correspond to a certain number of children within the daycare, or in other terms, the size of the second user's facility or capacity of the childcare provider. For example, a day care center may be more than six children a small day care center may be up to six children. The input of the second user services 1008 may correlate to the service (812 of FIG. 8B) and the age range (814 of FIG. 8B). When the first user inputs the services 812 and the age range 814 into the first user data of the first user record, the server may define these inputs as first user search parameters and retrieve the second user records that have the second user services 1008 that satisfy or correspond to the service 812 and age range 814 entered by the first user. The number of children provided or cared for under the services is important to convey to the first user the quality of the provider-childcare relationship. For example, a smaller day care provider having up to 6 children may be more hands-on and interactive with the child as compared to a larger day care center having a large plurality of children to care for. That is not to say that the larger day care center does not offer its own benefits, for example, the large day care provider may have more child-to-child interactions for the child to develop more social skills among peers. This information is important to the first user, i.e., the parent, to determine the needs of the child, such as educational, learning, and social needs. As shown, the services may include, but are not limited to, nursery schools, day care centers, small day care centers, group childcare, group family-based day care homes, family day care homes, and school-aged childcare. Additionally, the user may click a button that opens a prompt to add license information 1010, which provides qualifications for the second user. The user may enter information given by the federal agency of country in which they are providing childcare services. For example, in the United States, the Office of Child Care gives licenses with requirements that may vary from state to state. License information may include, but is not limited to, the type of service being provided, ID or permit number, effective date range including the issue date and expiration date, maximum capacity of children, allowed age range of children, and the gender of children. By themselves, the names of the types of services say nothing to the parents. However, parents are often focused on a certain number of children that providers have in daycare. These selections and user inputs will be stored in the second user record as second user data and may be used to predefine the second user search parameters.

Additionally, as shown in the example interface in FIG. 10B, the second user may also be prompted to enter a second user geographic location 1012. The second user may enter the desired address of the location, including the street address, city, state, and zip code. The second user may also click a button 1014 to enable the system to engage the GPS or cellular location devices of the first user computing device to determine the second user's current location. Some second users may have a plurality of addresses if they have more than one location. The interface may further prompt the second user to input contact information such as a contact phone number 1016 or a fax number. The interface may prompt the user to enter visiting hours 1017 including a range of time and day of the week. The interface may further include a slider, configured to allow the user to select a predetermined working hours 1018, of which the user may provide the childcare services of the first user. This input may correspond to the search parameters which may retrieve second user records having second user operating hours that correspond to the first user working hours. In other embodiments, the user may click on the hours available, enter specific times of the day, or enter a total number of hours available for the second user to care for the first user's child.

In other embodiments, the interface may include inputs which allow the second user to enter in the second user data to be stored on the first user record such as specific facilities 1020 of the second user. The specific requirements may include food and dietary facilities such as food prepared by the second user, food supplied by an outside provider, food brought from home, and other nutrition; sleeping arrangements such as no sleeping or nap time in the second user facility, cots/cribs available for sleeping, other sleeping areas; transportation such as whether the second user may provide transportation for the child of a first user to the second user facility or whether the second user provides transportation such as a bus stop/schedule; and playground access for the children. Likewise, the user may input classes and activities 1022 that are offered by the second user, for example swimming, dancing, or sports. Other classes and activities input by the user are within the spirit and scope of the disclosure. These selections and user inputs will be stored in the second user record as second user data and may be used to retrieve stored second user records which correspond to a first users search parameters. The second user may also provide specific languages 1024 that may be spoken which may be input into the system.

As shown in the example interface in FIG. 10D, the second user may be prompted to input a second user prices 1026. The example interface includes a prompt to input a registration fee 1028 and a prompt to add prices of each of the second user services. The interface further includes a prompt to input the service type 1030, child age 1032 of the service, available openings 1034 of the service, and price 1036 of the service. The user may choose to display the availability status 1038 or the number of openings 1040 by clicking the corresponding user interface element 1042, such as a checkbox. Other user interface elements may be used and are within the spirit and scope of the disclosure. The interface may include a table that displays the user inputs before the second users finishes entering the prices. The server may user these inputs to retrieve stored first users which include a price range corresponding to these prices. The second user may input the parameters of 1026, 1028, 1030, 1032, 1034, and 1036 by interacting with the second user interface via a dropdown menu, for example, to select from predetermined inputs or manually type or enter the parameters in a text field. Other user interface elements may be used and are within the spirit and scope of the disclosure.

With reference to FIGS. 11A through 11C, an example graphical representation of the stored second user record is shown. In this example embodiment, the stored record may only be accessible by the second user on the second user interface. When the second user accesses the stored record, the server may retrieve previously stored record 204, send data packet 202, which is sent to the first user computing device as data packet 210 which may contain the information for displaying the second user data and second user record on the second user computing device. The data packet 210 may allow the user to edit the second user record on the interface which may permanently alter stored record 204. This particular display on the second user computing device is a profile that only the second user can access. The second user may access the entirety of its stored record including the saved second user search parameters 1102; the second user identifying information having for example the second user provider name 1104, second user logo 1106, second user owner name 1108, license information 1109, second user contact information 1110 including contact phone number, fax number, website address, and social accounts; the first user geographic locations 1112 having a street name, city, state, and zip code; the second user services 1114; the description of the second user facility 1116 including a team members list 1118; the second user prices 1120; and the second user hours of operation 1122. The user may select a different page or tab that displays another interface comprising the second user prices stored on the second user record. Additionally, on the second user interface, the data in data packet 210 may include displaying the marketing material 1124 as described in FIG. 6. The marketing material may include advertisements, videos, pictures, prices, embedded links, and offers from or relating to the second user. If the second user is receiving the marketing material in data packet 210 that is displayed on the second user interface, then the second user record, which may include the saved second user search parameters, second user identifying information, second user geographic location, the second user services, the description of the second user facility, the second user prices, or the second user hours of operation, satisfies the advertising parameters of the second user.

Referring now to FIGS. 12A and 12B, a first user graphical display is shown, according to an example embodiment. The first user graphical display, as shown, is an example of the display that the first user graphical display data is configured for displaying on the first user computing device. It is important to note that the display of these embodiments may also be displayed on the second user computing device and/or third user computing device. When the display is on the second user computing device it will define the second user graphical display which would have been received over the communications network in the second user graphical display data. Likewise, when the display is on the third user computing device it will define the third user graphical display which would have been received over the communications network in the third user graphical display data. As shown, the embodiment of FIGS. 12A and 12B include the map and the second user graphical indicators. When the display is the second user graphical display, the map will define the second map and the indicators will correspond to the first user records and/or the third user records of which will define the first user graphical indicator and second user graphical indicator respectively. Similarly, when the graphical display is the third user graphical display, the map will define the third map and the indicators will correspond to the plurality of second user records shown as the second user graphical indicators.

Referring now to FIG. 12A, the first user interface is shown. In certain embodiments, the first user interface, configured for receiving the first user search parameters, may be displayed coinciding to the first user graphical display on the first user computing device. The first user interface and the first user graphical display, as well as the second user interface, the second user graphical display, the third user interface and the graphical display in other embodiments, may be configured to allow the user to interact with the interface, and/or webpage, such that the interface(s) and display(s) may include a plurality of user interface elements such as input controls, navigation components, informational components, and containers. Such user interface elements may include for example, accordions, bento menu(s), breadcrumb(s), button(s), card(s), carousel(s), check box(es), comment(s), doner menu(s), dropdown(s), feed(s), form(s), hamburger menu(s), icon(s), input field(s), kebab menu(s), loader(s), meatball menu(s), modal(s), notification(s), pagination(s), picker(s), progress bar(s), radio button(s), search field(s), sidebar(s), slide control(s), stepper(s), tag(s), tab bar(s), tool tip(s), and toggle(s). The first user can interact with the user interface elements to input the first user search parameters 1202. The first user search parameters may include for example, the second user service type 1204, the child information such as child age or age range 1206 that corresponds to the ages of children that the second user provides its services for, the availability of the second user services 1208 which indicate whether the first user would need to use the first communication tool to request to be placed on the second user waiting list, the second user working hours 1210 and hours of operation, the classes and activities 1212 offered by the second user, and the average second user rating 1214. Any information contained within a second user record search parameters may be used to define the first user search parameters. As shown for example, the first user can input the first user search parameters using the user interface elements having check boxes 1216 and a slide control 1218.

The map 1220 may include a graphical representation of the area having the predetermined location of the first user search parameters. The predetermined location may be a location that the user desires to search for a provider's services. The map may incorporate pre-existing map provider services such as Google Maps™, Google Earth™, and Google Street View™ for example. The graphical representation of the map may be a satellite image of the geographic location or a roadways map of which the user can interact with on the first user interface and first user graphical display. The map 1220 may include a zoom-in button 1221 and a zoom-out button 1222 to adjust the field of view of the map.

Furthermore, the quick search parameters 1223 and 1224 may be disposed on the map. The system may be configured such that a gesture input by the user allows the user to engage the quick search parameters to perform a search. Quick search parameter 1223 may include the geographic location of which the first user would like to search for the second users. The quick search parameter 1223 may include a text field 1223A for the user to type in an address, stored first user geographic location 1223B which is the first user's home address, stored first user geographic location 1223C which is the first user's work address, and/or stored first user geographic location 1223D which is any other stored first user geographic location of the first user record. The quick search parameter 1223 may also be configured to search a predetermined radius on the map from the said location for satisfying second user records. Each of the quick search parameters, 1223, 1223A, 1223B, 1223C, and 1223D may be represented by a button having an icon corresponding to the specific location. For example, the first user's home address 1223B may be represented by an icon of a home, the first user's work address 1223C may be represented by an icon of an office. Generally, the quick search icon 1223 may be represented by an icon of a map or geo location pin. Quick search parameter 1223 may further include a confirmation icon 1225 which is displayed proximate to the geographic location which was used in the first user search parameters. The confirmation icon may be depicted as a checkmark or other indicator to reflect positive reinforcement for the user, so the user can quickly identify which of the plurality of stored geographic locations was used to conduct the search. Quick search parameter 1224 may include the first user child information. The first user record may store information corresponding to each of the first user's child. Each of the first user's children may be represented by the quick search parameter 1224 such as quick search parameter 1224A and 1224B. Quick search parameter 1224 may be used to search for a second user than can care for all of the second user's children and may include an icon depicting multiple children so that the user can quickly identify that the search parameters correspond to all of the first user's children. The quick search parameter 1224 may also include a total indicator 1226 disposed proximate to the quick search parameter 1224 where the total indicator includes a numerical representation of the total number of children that are included in the search parameters. Additionally, the first user may choose to search for a second user, or care provider, for each child separately. To do so, the first user may select quick search parameter 1224A or 1224B each of which may correspond to a different child and its corresponding child information that is stored within the first user record. The first user can quickly change the search parameters without conducting entirely new search parameters by clicking or filtering between the quick search parameters 1223 and 1224. For each of the first user search parameters that are entered, the first user search parameters are stored in the first user record. The quick search parameter 1224 may be configured to calculate the child's age. For example, the system continuously reads the first user's record to access the date of birth of the child from the child information. The system, using the processor, calculates the current age of the child by determining the elapsed period of time between the child's date of birth and the current date. The system then updates, or writes, the first user search parameters to reflect the first user's child age of the first user child search parameters. Because the system provides a continuous update to the child's age, the first user search parameters, the second user records that satisfy the first user search parameters, and the displayed results via the second user graphical indicators on the map are a dynamic system continuously in communication with the server over the communications network. Other quick search parameters may be disposed on the map and are within the spirit and scope of the disclosure. For example, in other embodiments, a quick search parameter allowing the user to quickly filter the second users having availability may be disposed on the map. Additionally, the second user graphical indicators may be colorized according to their availability, for example, a green second user indicator may indicate availability for the second users services and/or vacancies within the second user's facility, whereas a second user indicator gray in color may indicate that the second user does not have availability and that the first user will have to use the first communication tool to send a request to the second user to join the second user waiting list. Other colors may be used and are within the spirit and scope of the disclosure.

Additionally, the first user may click on a favorite button 1228 which will save the specific search parameters, including the specific quick search parameters and the corresponding results, to the first user record. The user may use a gesture such as a physical touch where the interface is a touch screen interface, or a gesture with a computer mouse 1230. The gesture with the computer mouse may be a click, swipe, click and drag function, a predetermined movement of the computer mouse such as moving the mouse proximate to a user interface element and/or second user graphical indicator. Other computer gestures to select and/or deselect user interface elements are within the spirit and scope of the disclosure.

With reference to FIG. 12B, the first user graphical display is shown after the system receives the first user search parameters and determines the second user records that satisfy the first user search parameters. The second user graphical display may display a plurality of second user graphical indicators such that each second user graphical indicator corresponds to a different second user record that satisfies the first user search parameters. The first user graphical display may also include quick search parameters 1223, and 1224 to allow the user to quickly change the first user search parameters after conducting an initial search. In certain embodiments, the first user graphical display may also include a filter parameter 1225. The filter parameter may include a user interface element, such as a checkbox or a button for example. When the user engages with the filter parameter, the system will filter which of the second user graphical indicators correspond to the filter parameter and dispose only those that satisfy the filter parameter on the map. For example, quick filter parameter 1225 may include a “see all” filter 1225A and/or a “see all available” filter 1225B. The “see all” filter may be configured for displaying all the second user graphical indicators on the map that correspond to second user records that satisfied the first user search parameters. The “see all available” filter may be configured for displaying all the second user graphical indicators on the map that correspond to second user records that satisfied the first user search parameters and where the second user records also indicate that the second user services have availability and/or vacancies for the first user to apply for the second user services. Other quick filter parameters 1225 having specific characteristics of the second user records that are configured to sort the second user records that satisfy the first user search parameters are within the spirit and scope of the disclosure.

As shown, the map may have a plurality of second user graphical indicators disposed on the map corresponding to the second user graphical location. To determine the position of the graphical indicator on the map, the server reads the second user record to access the second user geographic location. Because the first user graphical display is a dynamic system, as the first user changes the first user search parameters or the changes the field of view of the map or geographic location, then the map will update with new second user graphical indicators that correspond to the second user records that satisfy the updated first user search parameters.

The second user graphical indicator 1232 may be defined by a geopin, teardrop, or other symbol to indicate the presence of a second user on the map. Each of the second user graphical display may be configured to display the second user graphical indicators having different sizes or colors where the size and color of the second user graphical indicator may correspond to the extent that the second user record satisfies the first user search parameters. In other words, for example, the second user graphical indicator may be larger than other second user graphical indicators if second user record has more information that corresponds to the first user search parameters than other second user records. Therefore, the when the system receives the first user search parameters, the system may read each of the second user records, determine how much of the second user record satisfies the first user search parameters, and compare the second user records with the other second user records that satisfy the first user search parameters. For example, if one second user record matches or satisfies more first user search parameters than another second user record, then the second user record that satisfies more search parameters may be displayed as the second user graphical indicator being green in color and the second user record that satisfies less first user search parameters may be displayed as the second user graphical indicator being yellow or red in color. Other embodiments configured to display to the first user which of the second user records is a better match for the first user search parameters are within the spirit and scope of the disclosure.

Additionally, once a gesture is received proximate to a second user graphical indicator, that second user graphical indicator may be configured to display larger than other second user graphical indicators. For example, second user graphical indicator 1232 is a selected second user and defines a selected second user graphical indicator of which may appear larger than other second user graphical indicators, such as second user graphical indicator 1233 for example.

After a gesture is received by the server proximate to the second user graphical indicator, then the second user graphical indicator may be configured for displaying the second user record 1234. The second user graphical indicator 1232 includes the display of the second user record 1234 such that the second user graphical indicator may display the second user identifying information 1236, such as the name of the second user, the second user services 1238, the second user age range 1240, the second user rating 1242, and the availability of the second user services via the first communication tool 1244, which may be displayed as a button defining the first user communication tool. For example, if the second user graphical indicator displays availability corresponding to the age group, then the first user may perform a gesture, such as clicking on the button with the mouse 1230. By clicking on the button, the communication tool may either send an application to apply for the second user's services. Alternatively, if there is no availability, the first communication tool may send a request to join the second user waiting list. The age range 1240 may correspond to the second user services (1008 of FIG. 10A). Only the second user services that correspond to the first user search parameters may be display on the second user graphical indicator. For example, if the second user indicates that it services are for toddlers ages (1-2) years old and teens ages (10-14), and the first user inputs the services (812 of FIG. 8B) and age range (814 of FIG. 8B) being a toddler or age of (1-2), then only the services for toddler will be displayed because it is the second user record that corresponds to the first user search parameters. In other embodiments, the second user graphical indicator may include the maximum capacity or maximum number of children allowed to be cared for by the second user according to either law and/or the second user's license. As previously mentioned, the type of service 1238, such as day care, may correspond to the allowed number of children, such as up to six children for a small day care and more than six children for a day care center. Other numerical capacities of children for each service are within the spirit and scope of the disclosure and may be displayed on the second user graphical indicator depending on the second user data entered by the second user to generate the second user record. The second user may change the indication of the services if the license information correspondingly changes.

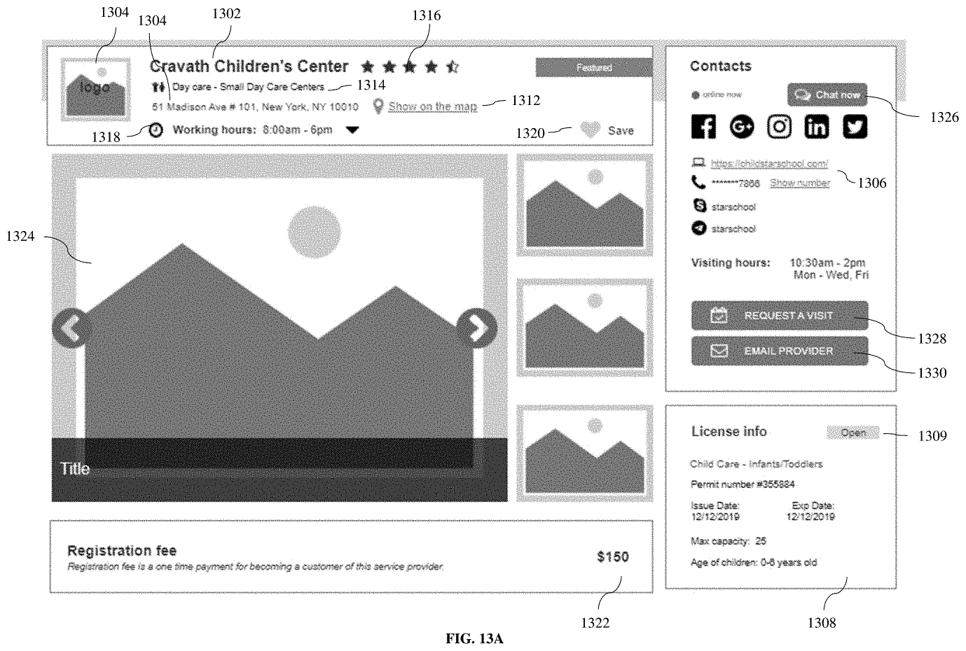

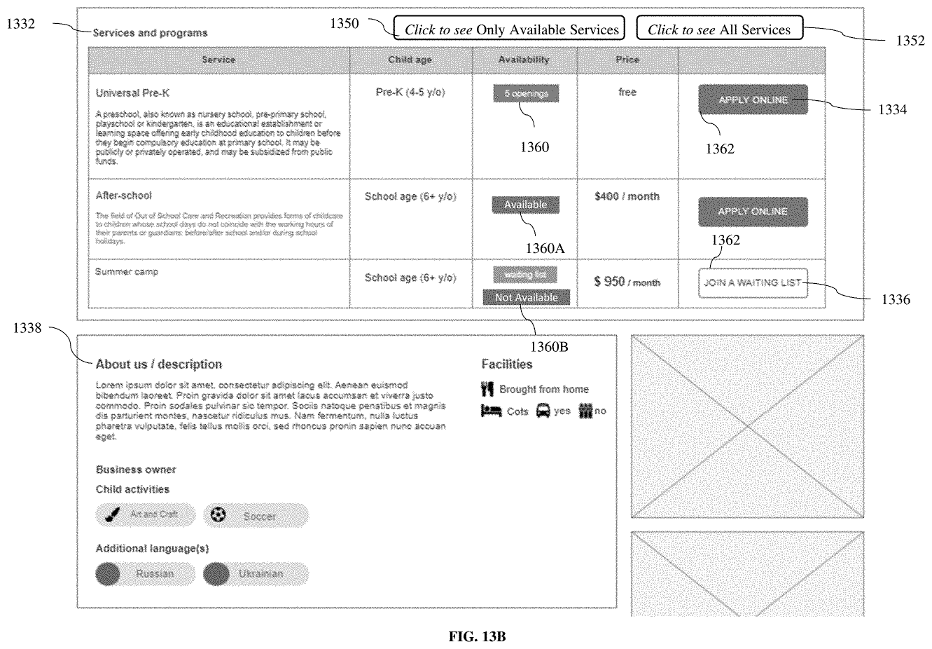

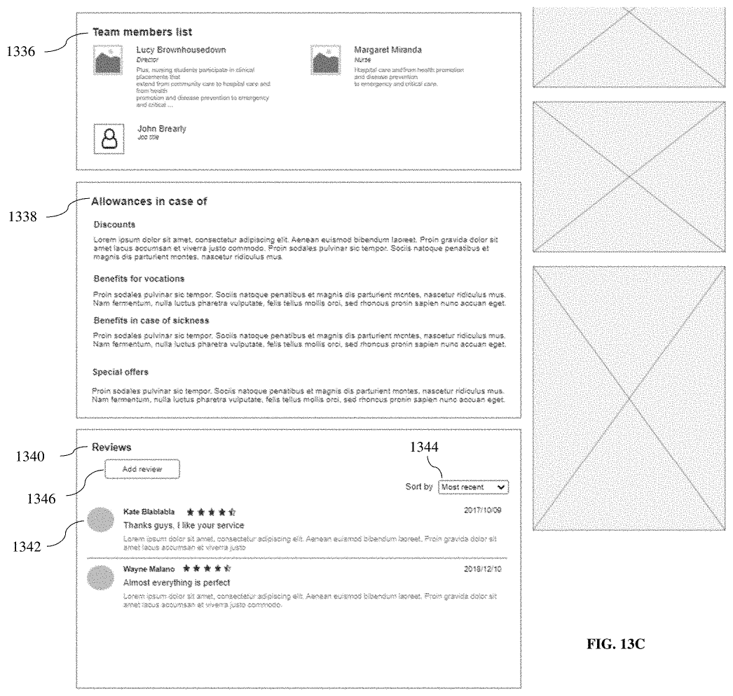

In other embodiments, the second user graphical display may have each of the second user graphical indicators 1234 displayed proximate to the map 1220 as a list of the second user records 1246. The list of second user records 1246 may be a tab or button, similar to search parameters 1202, of which the first user may input a gesture to toggle between the list of the second user records and the search parameters to input new search parameters thereby changing the list of the second user records having the second user records that satisfy the first user search parameters. The second user graphical indicator 1234 may also include the second user price 1248 and/or second user registration fee. The price may be the cost of the second user services or second user goods for example. The price may also be the registration fee for applying/submitting an application to the second user and/or, in other embodiments, the cost per child per month or any other required period (week, day, hour, etc.) to attend the second user facility to receive the second user services. Additionally, the second user graphical indicator may display icons 1250 relating to other information within the second user record that satisfies the first user search parameters, such as education or classes offered, sleeping, napping, or lodging, food supplied, and/or handicap or disability compliant or friendly, for example. Other icons and pictorial representations may be displayed on the second user graphical indicator 1234 corresponding to information within the second user record that satisfies the first user search parameters. Moreover, the second user graphical indicator 1232 and/or 1234 may be configured to receive a gesture to display more details about the second user, such as displaying the second user record. The resulting displayed second user record is defined as a selected second user having a corresponding selected second user record of which is further detailed in FIGS. 13A through 13C.

The first user interface and/or the first user graphical display may be configured to display the marketing material 1250 received over the communications network from the second user. The marketing material allows each second user, provider, to have the ability to reach a targeted first user, customer, through advertisements, promotions, announcements and other useful information for customers, alleviating the burden of providers needing to create and run their own websites and search marketing campaigns. The advertisement/marketing material 1250 will be displayed on the first user interface and/or graphical display if the first user record satisfies the advertising parameters of the second user which may include the first user geographic location and the first user child information, such as age and/or gender. Currently, providers are reliant upon an ad-hoc network of service providers and DIY advertising to promote and establish their business. The competitive market means that providers who are not well-known must market their childcare service in local newspapers, Yellow Pages advertising and Internet advertising. The system improves upon the prior art by replacing the need for individual/independent second user websites therefore saving the second user money. The system supports revenue generating methods, such that the second user, provider, pays to the operator of the server 102 a listing fee and completes required key information for a detailed listing to become a verified listing and a premium second user. In certain embodiments, to determine which of the first user records and/or third user records satisfy the advertising parameters, the system may utilize search engine optimization, meaning that second users, providers, will be displayed in the advertising area 1250 based on organic search results of the first user search parameters and the third user search parameters respectively. For example, when the server receives each of the first user search parameters, the system compares the first user search parameters with the advertising parameters. If the first user search parameters satisfy the advertising parameters, then the marketing material will be sent by the server across the communications network to the first user computing device to display the marketing material on the first user interface and/or the first user graphical display as marketing material 1250. In certain embodiments, the advertising parameters uploaded to the database from the second user can then be linked by the provider and replicated on free Internet resources (such as Facebook, Twitter, etc.).

In other embodiments, the FIGS. 12A and 12B may be sent over the communications network in the data packet having the second user interface and the second user graphical display data configured for displaying the embodiment on the second user computing device. When the map 1220 is displayed on the second user computing device as generated from the second user graphical display data, the map defined the second map. Similarly, the search parameters 1220 shall define the second user search parameters of which the elements 1204 through 1214 may correspond to at least one of information stored within a first user record and/or a third user record; for example, a first user child age, a first user geographic location, third user services, third user average reviews, etc. After the server receives the second user search parameters and stores them to the second user record, the system determines which of the first user records and/or third user records satisfy the second user search parameters. The second user graphical display data is sent again having the first user graphical indicators and the second user graphical indicators, such as the graphical indicator 1232, 1234. The first user graphical indicator is disposed on the second map corresponding to the first user geographic location. Likewise, the third user graphical indicator is disposed on the second map at the third user geographic location. The first user graphical indicator may include data the first user record, such as the first user name and first user child information for example. Similarly, the third user graphical indicator may include the third user record, for example, the third user name, the third user rating, the third user services, and the third user price. The third user services may include information or data about the services that the third user is providing or intends to provide. The third user goods may include information or data about the goods that the third user is providing or intends to provide. The third user prices may include information or data about the prices of the goods and services that the third user is providing or intends to provide. The third user hours may include information or data about the hour of operation that the third user is providing or intends to provide.

Moreover, each of the first user graphical indicator and the third user graphical indicator may include user interface elements, such as a button, defining the second communication tool configured to communicate with each of the first users and third users respectively. Additionally, in certain embodiments, the quick search parameter 1223 may correspond to the second user geographic location of each of the second user's facilities and/or a predetermined radius from the said location. Quick search parameter 1224 may correspond to the users/graphical indicators on the map, such as the first user graphical indicator and the third user graphical indicator, where the second user may click, for example, on the quick search parameter 1224 and filter between having the first user graphical indicators and/or the third user graphical indicators coincidently disposed on the second map.

Similarly, to the first user interface and the first user graphical display, the system may send to the third user computing device, the third user interface data and/or the third user graphical display data having the third map 1220, the third user search parameters 1202, and the second user graphical indicators 1232, 1234.

Referring now to FIG. 13A through 13C, a first user graphical display of the selected second user record is shown, according to an example embodiment. The first user graphical display, as shown, is an example of the display that the first user graphical display is configured for displaying on the first user computing device. It is important to note that the display of these embodiments may also be displayed on the second user computing device and/or third user computing device. When the display is on the second user computing device it will define the second user graphical display which would have been received over the communications network in the second user graphical display data. Likewise, when the display is on the third user computing device it will define the third user graphical display which would have been received over the communications network in the third user graphical display data. As shown, the embodiment of FIGS. 13A through 13C includes the selected second user and the second user data of the selected second user. When the display is the second user graphical display, the selected user will define the selected first user and/or selected third user and the user data will correspond to the selected first user and/or the selected third user of which will define the first user data and third user data respectively. Similarly, when the graphical display is the third user graphical display, the selected user will define the selected second user and the user data will correspond to the selected second user which will define the second user data.

Referring now to FIG. 13A, a first user interface display is shown. The first user interface and the first user graphical display, as well as the second user interface, the second user graphical display, the third user interface and the graphical display in other embodiments, may be configured to allow the user to interact with the interface, and/or webpage, such that the interface(s) and display(s) may include a plurality of user interface elements such as input controls, navigation components, informational components, and containers. Such user interface elements may include for example, accordions, bento menu(s), breadcrumb(s), button(s), card(s), carousel(s), check box(es), comment(s), doner menu(s), dropdown(s), feed(s), form(s), hamburger menu(s), icon(s), input field(s), kebab menu(s), loader(s), meatball menu(s), modal(s), notification(s), pagination(s), picker(s), progress bar(s), radio button(s), search field(s), sidebar(s), slide control(s), stepper(s), tag(s), tab bar(s), tool tip(s), and toggle(s). The second user graphical indicator that the first user inputs a gesture, such as clicks on, defines the selected second user graphical indicator. A first user's gesture proximate to the selected second user graphical indicator on the first user map triggers the first user's computing device to send the selected second user data in data packet 208 to the server 102 via the communications network. The selected second user data includes data about which second user is chosen by first user. The server computes which second user record corresponds to the selected second user data and send the corresponding second user data in data packet 202 over the communications network. Data packet 202 may also include data configured to display the first user graphical display. The first user computing device receives data packet 202 as data packet 206 via transceiver. The first user interface display shows the second user data from the selected second user record, including the second user identifying information, second user geographic location, second user services, and a description of a second user facility, second user price, and second user hours of operation. The first user interface may display the second user identifying information including the provider's name 1302, image of a logo 1304, contact information 1306, and license information 1308. The contact information may include graphical indicators comprising the selected second user's social media links. The contact information may also include a phone number and a hyperlink to the website of the second user. The license information may be given by the federal agency of the country in which they are providing childcare services. For example, in the United States, the Office of Child Care gives licenses with requirements that may vary from state to state. License information may include, but is not limited to, the type of service being provided, ID or permit number, effective date range including the issue date and expiration date, maximum capacity of children, allowed age range of children, and the gender of children. The first user may click a button 1309 to open a display comprising additional information of the license. The first user interface may also include the second user geographic location including the full address 1310 of the second user along with a graphical indicator 1312 proximate to the address allowing the first user to show the second user graphical indicator on the map. The first user interface may further display second user services 1314 provided by the second user, second user rating 1316, and second user hours of operation 1318, all of which are disposed proximate to the second user identifying information. The first user interface also includes a graphical indicator that the user may interact with to save 1320 the selected second user record. Second user price 1322 and an interactable slideshow of the and an interactable slideshow 1324 of provider images are also displayed by the first user interface. The first user interface further includes communication tools allowing the first user to initiate communication with the second user. The communication tools may include buttons allowing the first user to chat 1326, request a visit 1328, and send an email 1330 to the second user. The button allowing the first user to chat with the second user may include a message service, click to call button, and chat options. The second user can view chats from first users and answer back on the mobile app. Users will opt-in to receive notifications and offers by email when initiating a chat with the second user. The button allowing the first user to request a visit causes the first user to be placed in a second user's queue for coordination of the visit, if the second user elects to offer this option in a paid listing.

Referring now to FIG. 13B, the first user interface may further display a service chart of services and programs 1332 to give more detail of the second user services of the selected second user record. The first user interface includes the service chart area based on the second user data comprising at least one of second user number of vacancies and second user availability. The service chart may include the service name, brief description of service, child age, availability, and price. The table allows the first user to see which service and program is more catered to the first user's preferences. The service column includes the service name and a description of the service. The child age column provides the range of ages that the corresponding service is for. The availability column may display either the availability status or the number of vacancies in the corresponding service or program depending on what the selected user chose when creating a profile (as shown in FIG. 10D). In the present embodiment, the availability column displays a graphical representation 1360 that includes the number of openings or vacancies in the corresponding service. In other embodiments, the graphical representation 1360 may include the availability status, which may be displayed as “available” or “not available” for example. By allowing the second user to decide whether to display the number of vacancies and/or the availability status of the services, the system offers increased market competition among second users. For example, if one second user only shows availability status whereas another second user shows the number of vacancies; it may create an implied urgency for the first user to apply, using the input field, to the second user. The first user may be more inclined to submit an application to the second user showing limited vacancies for fear of missing out on the services. Similarly, if the second user has many vacancies, the second user may not want to be as transparent with the first user therefore limiting the inferences that the first user can make about the second user and the corresponding demand for its services.

The availability column shows the first user how many openings are left for children in the service or program. The price column shows how much a service or program is. The last column provides an input area 1362 that receives a gesture for the first user to at least one of apply online to fill a vacancy of the second user and to be added to the second user waiting list. The input area may be an interface element, such as button in the present embodiment, for each service allowing the first user to apply or join a waitlist for the corresponding service or program. It is understood that the input area may be other interface elements that are within the spirit and scope of the present invention. If the service has at least one opening, the button will indicate that the first user may apply online. If the service has no openings left, the button will indicate that the first user may join a waitlist. The system will allow users to submit an application to be held in the queue. As the waiting list status is updated, the platform will notify users through email and push notifications. The service chart may also include a button allowing the first user to apply online 1334 to a certain service or program and another button allowing the first user to join a waiting list 1336 for a service or program. The user may filter the table to only show available services by clicking the user interface element 1350. Available services means that the second user has indicated either a number of vacancies 1360 and/or available status 1360A for space in the second user's facility. In other terms, the available services will remove any services that require the first user submitting a request to join the second user waiting list or those not available 1360B. The user may choose to view all services including available and unavailable services by clicking another user interface element 1352. This will show all services that have an available status 1360A, a number of vacancies 1360, and a waiting list and/or not available status 1360B. The user interface element may be a button that the user may click. Other user interface elements may be used and are within the spirit and scope of the disclosure. The first user interface may also display the second user brief description 1338 of facility along with activities, languages, and facilities offered by the second user.

Referring now to FIG. 13C, the first user interface further displays a team members list 1336 to show the current employees working at the childcare facility. The list includes the name, job title, and job description of each team member. The allowances 1338 are also displayed on the interface to inform the first user about discounts, benefits for vocations and in case of sickness, and special offers. Additionally, the first user interface includes reviews 1340 of the selected second user. The first user may read published reviews 1342 of the second user and may sort the reviews using the dropdown box 1344, which includes options to sort the reviews by the most recent, oldest, highest rating, or lowest rating. Each published review includes the name of the reviewer, the given rating and written review for the second user, and the date of the review. The first user interface further displays a button 1346 allowing the first user to add a review for the selected second user.

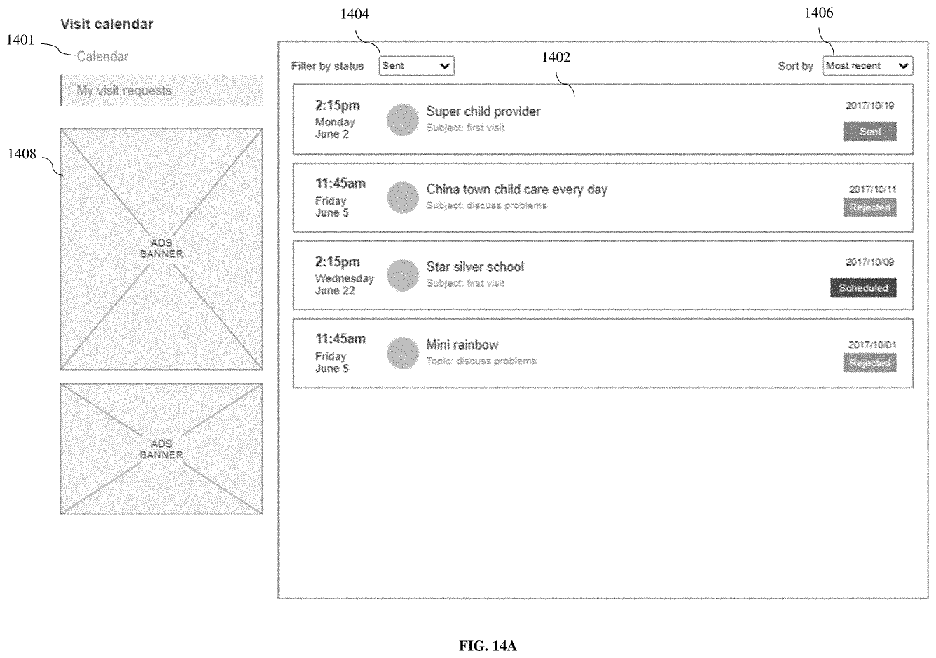

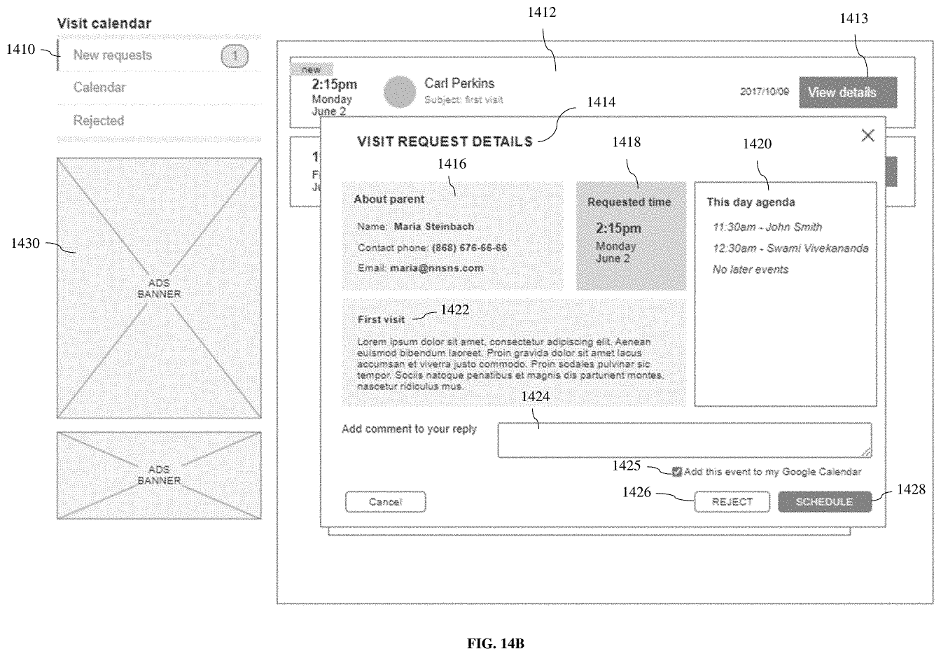

Referring now to FIG. 14A through 14B, the first user graphical display of a first communication tool and the second user graphical display of a second communication tool are shown. The server sends the first communication tool in data packet 202 through the communications network and into the first user computing device 110 as data packet 206. The first communication tool allows the first user computing device to communicate with the second user computing device 114. When the first user 108 clicks on the buttons in FIG. 14A to request a visit 1328, submit an application 1334, or join a waiting list 1336, data packet 208 comprising first user communication request data is sent through the communications network and stored by the server as data packet 204. Before the data packet is sent, the user may be prompted to answer questions depending on the request about the age and number of children needing the second user's services. The first user communication request data in data packet 208 may include answers from the prompted questions and other request information such as date and time of request. For a visit request, the first communication request data may include data that includes the requested date and time of the visit along with a message from the first user. For a waitlist request, the first communication request data may include the age and number of children needing to be waitlisted. However, it is understood that other information may be included in the first communication request data. Then, the data packet 202 comprising the first communication request data is sent through the communications network to the second user computing device as data packet 210. The data packet 202 may have the user interface and/or the user graphical display data configured to display the user interface and/or the graphical display.

The server sends the first communication tool in data packet 202 through the communications network and into the second user computing device 114 as data packet 210. The second communication tool allows the second user computing device to communicate with the first user computing device 108 and the third user computing device 116. When the second user 108 activates a gesture to send a second user offer to the first user, a second user request for the third user's goods and services, and a second user request to join the waiting list for the third user's goods and services, data packet 212 comprising second user communication request data is sent through the communications network and stored by the server as data packet 204. The second communication request data in data packet 210 may include answers from prompted questions and other request information such as date and time of an offer or request. However, it is understood that other information may be included in the second communication request data. Then, the data packet 202 comprising the second communication request data is sent through the communications network to the first user computing device as data packet 210 or third user computing device as data packet 214. The data packet 202 may also have the user interface and/or the user graphical display data configured to display the user interface and/or the graphical display. A third communication tool is sent the third user 116 allowing the third user to send third communication tool request data comprising a third user offer to the second user. As mentioned above messages, offers, requests may be presented to the other users in the form of SMS messages, emails, displays, graphical indictors indicating a notification to the user.

Referring now to FIG. 14A, the first user graphical display, or first user interface, of the first communication tool is shown, according to an example embodiment. The first communication tool allows the first user to view the statuses of the requests they sent to second users. As shown in the example graphical display, the first user interface includes a tab 1401 displaying a list of the first user's visit requests. The first user interface may also include a tab for displaying the online applications or waitlist requests sent by the first user. Each entry 1402 in the example interface includes the name of the second user that a request was sent to, and the subject of the message sent by the first user. The entry may also include the requested date and time of the visit and the date and time of when the request was sent. Most importantly, the entry includes the status of the visit request allowing the first user to know whether the visit request is accepted, rejected, or pending. The first user interface also includes a dropdown box 1404 allowing the first user to filter the requests by the status and a second dropdown box 1406 allowing the first user to sort the requests by most recent or oldest. The first user interface may also include advertisements 1408 configured to display marketing material consistent with the methods in FIG. 6 proximate to the edge of the interface. When the display is on the third user computing device it will define the third user graphical display which would have been received over the communications network in the third user graphical display data. The display would include the third communication tool allowing the third user to view requests from second users including requests for the third user's goods and services and requests to join the waiting list for the third user's goods and services.

Referring now to FIG. 14B, the second user graphical display, or second user interface, of the second communication tool is shown, according to an example embodiment. The second communication tool allows the second user view requests from first users and offers from third users. As shown in the example graphical display, the second user interface includes a tab 1410 displaying a list of visit requests from the first users. The second user interface also includes a tab to view the calendar and another tab to view visit requests that the second user rejected. Additional tabs may be included comprising a list online applications and waitlist requests from the first users and a list of offers from the third users. Each entry 1412 includes the name of the first user, subject line, requested date and time for the visit, and date and time the request was sent. Each entry also includes a button 1413 that the second user may click allowing the second user to view the details of each 1414 visit request. The visit request details comprise information about the first user (parent) 1416, the requested date and time 1418, agenda 1420 of the day the visit is requested for, the message written by the first user 1422, a textbox 1424 allowing the second user to include a reply message, a checkbox 1425 allowing the second user to add the visit to their calendar if accepted, a reject button 1426 to reject the visit request, and a schedule button 1428 to accept the visit request. The information about the first user may include the parent's name and contact information. The first user interface may also include advertisements 1430 configured to display marketing material consistent with the methods in FIG. 6 proximate to the edge of the interface.

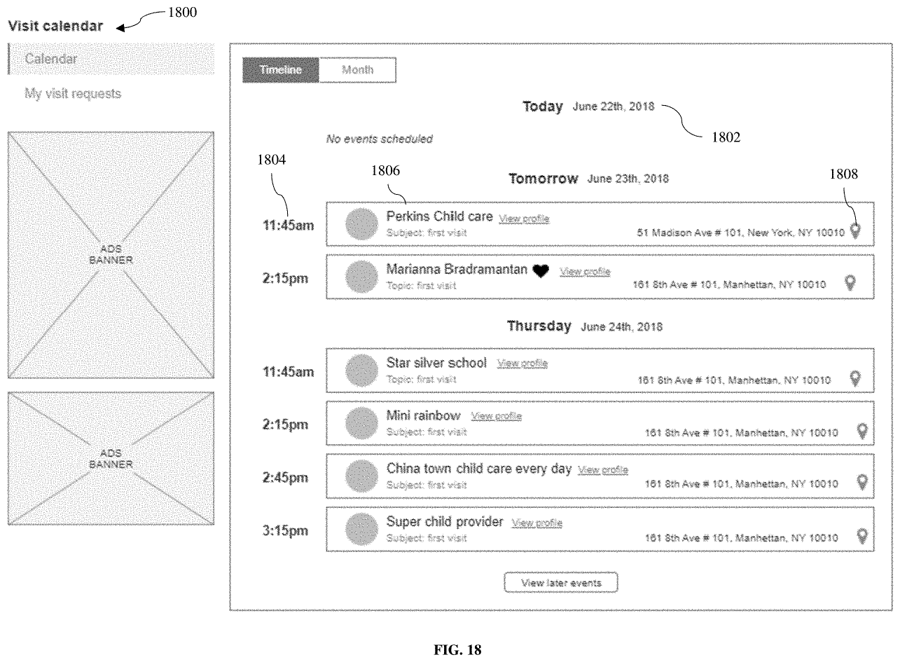

In another embodiment, the system may be configured for displaying the embodiment of FIG. 18, on each of the first user computing device, second user computing device, and third user computing device, a calendar including a schedule of requests sent and or received over the communications network using the communication tool of the respective computing device. The server may send the calendar across the communications network in data packet 202 to each respective computing device. The data packet 202 having the calendar may also have the user interface and/or the user graphical display data configured to display the user interface and/or the graphical display. The calendar 1800 may include dates 1802 represented by at least one of a day of the week, such as Monday, Tuesday, Wednesday, Thursday, Friday, Saturday, and Sunday; a calendar data in various formats such a “Month Day, Year”, “MM/DD/YYYY”, “YYYY/MM/DD”, and/or “DD/MM/YYYY”, and relative days such as “Yesterday”, “Today”, or “Tomorrow” for example. The calendar may also be configured to display times of day 1804. The calendar is configured to display the communication requests 1806 by the user. For example, the calendar of the first user may display the scheduled visitation requests of the first user. The calendar may display each of the communication requests having the communication request data indicating the second user identifying information, such as the name of the second user facility, and the second user geographic location. Additionally, the communication request 1806 may be configured to interact with the user such that it includes user interface elements configured to receive a gesture. Once the gesture is received the selected second user record may be displayed and/or details of the communication request data. Additionally, the communication request 1806 may include a second user graphical indicator 1808 where the second user graphical indicator is a button which will display the map and the second user graphical indicator disposed on the map at the corresponding second user geographic location of the second user. The calendar may include a plurality of events or communication requests 1806 organized on the calendar by date and time that the event is scheduled to occur.

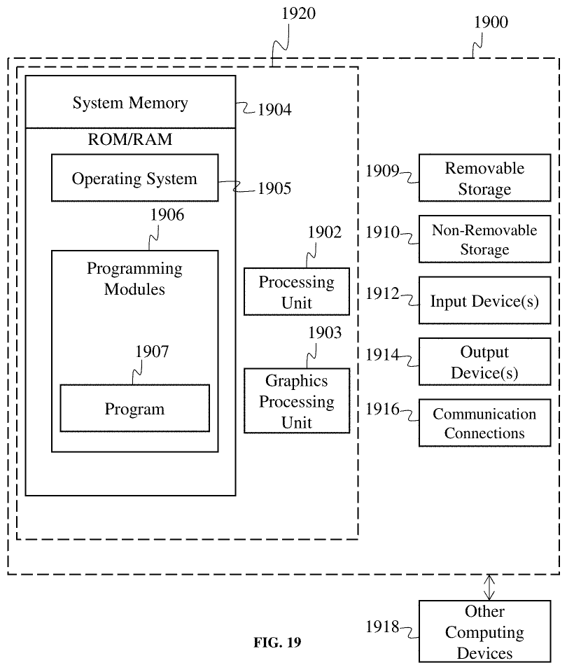

FIG. 19 is a block diagram of a system including an example computing device 1900 and other computing devices. Consistent with the embodiments described herein, the aforementioned actions performed by server 102 or computing devices 110, 114, and 118 may be implemented in a computing device, such as the computing device 1900 of FIG. 19. Any suitable combination of hardware, software, or firmware may be used to implement the computing device 1900. The aforementioned system, device, and processors are examples and other systems, devices, and processors may comprise the aforementioned computing device. Further-more, computing device 1900 may comprise an operating environment for the methods shown in FIGS. 3 through 7 above.

With reference to FIG. 19, a system consistent with an embodiment of the invention may include a plurality of computing devices, such as computing device 1900. In a basic configuration, computing device 1900 may include at least one processing unit 1902 and a system memory 1904. Depending on the configuration and type of computing device, system memory 1904 may comprise, but is not limited to, volatile (e.g., random access memory (RAM)), nonvolatile (e.g., read-only memory (ROM)), flash memory, or any combination or memory. System memory 1904 may include operating system 1905, one or more programming modules 1906 (such as program module 1907). Operating system 1905, for example, may be suitable for controlling computing device 1900's operation. In one embodiment, programming modules 1906 may include, for example, a program module 1907. Furthermore, embodiments of the invention may be practiced in conjunction with a graphics library, other operating systems, or any other application program and is not limited to any particular application or system. This basic configuration is illustrated in FIG. 1900 by those components within a dashed line 1920.

Computing device 1900 may have additional features or functionality. For example, computing device 1900 may also include additional data storage devices (removable and/or non-removable) such as, for example, magnetic disks, optical disks, or tape. Such additional storage is illustrated in FIG. 19 by a removable storage 1909 and a non-removable storage 1910. Computer storage media may include volatile and nonvolatile, removable, and non-removable media implemented in any method or technology for storage of information, such as computer readable instructions, data structures, program modules, or other data. System memory 1904, removable storage 1909, and non-removable storage 1910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 1900. Any such computer storage media may be part of device 1900. Computing device 1900 may also have input device(s) 1912 such as a keyboard, a mouse, a pen, a sound input device, a camera, a touch input device, etc. Output device(s) 1914 such as a display, speakers, a printer, etc. may also be included. The aforementioned devices are only examples, and other devices may be added or substituted.

Computing device 1900 may also contain a communication connection 1916 that may allow device 1900 to communicate with other computing devices 1918, such as over a network in a distributed computing environment, for example, an intranet or the Internet. Communication connection 1916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acous-tic, radio frequency (RF), infrared, and other wireless media. The term computer readable media as used herein may include both computer storage media and communication media.

As stated above, a number of program modules and data files may be stored in system memory 1904, including operating system 1905. While executing on processing unit 1902, programming modules 1906 may perform processes including, for example, one or more of the methods shown in FIGS. 3 through 7 above. Computing device 1900 may also include a graphics processing unit 1903, which supplements the processing capabilities of processor 1902 and which may execute programming modules 1906, including all or a portion of those processes and methods shown in FIGS. 3 through 7 above. The aforementioned processes are examples, and processing units 1902, 1903 may perform other processes. Other program-ming modules that may be used in accordance with embodi-ments of the present invention may include electronic mail and contacts applications, word processing applications, spreadsheet applications, database applications, slide presentation applications, drawing or computer aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configura-tions, including handheld devices, multiprocessor systems, microprocessor based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be prac-ticed in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the present invention, for example, are described above with reference to block diagrams and/or operational illustrations of methods, systems, and computer program products according to embodiments of the inven-tion. The functions/acts noted in the blocks may occur out of the order as shown in any flowchart. For example, two blocks shown in succession may in fact be executed substantially concurrently or the blocks may sometimes be executed in the reverse order, depending upon the function-ality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer implemented method for providing a marketplace for childcare related services between a plurality of first users and a plurality of second users, the computer implemented method comprising:
a. generating, with a processor of a computing device, a first user record for each of the plurality of first users, wherein each of the first user records comprises first user data comprising at least one of: (1) first user identifying information; (2) a first user geographic location; and (3) first user child information;
b. generating, with the processor, a second user record for each of the plurality of second users, wherein each of the second user records comprises second user data comprising at least one of: (1) second user identifying information (2) a second user geographic location; (3) second user services; and (4) a description of a second user facility;
c. storing the first user record and the second user record in a connected database;
d. sending with a transceiver of the computing device, over a communications network to a first user computing device associated with one of the plurality of first users, first user interface data for providing a first user interface configured for receiving first user search parameters input from the first user computing device, wherein the first user search parameters comprise at least one of: (1) a predetermined geographic location; (2) a searching age range; (3) required second user services; and (4) a minimum second user rating;
e. receiving with the transceiver, over the communications network from the first user computing device, the first user search parameters;
f. storing in the connected database, the first user search parameters in the corresponding first user record;
g. determining, with the processor, based on a plurality of second user records, which of the second user records satisfies the first user search parameters;
h. sending with the transceiver, over the communications network to the first user computing device, first user graphical display data for displaying a first user graphical display comprising a map and a second user graphical indicator that corresponds to each of the plurality of second user records that satisfy the first user search parameters,
wherein the second user graphical indicator comprises at least one of: (1) the second user record; (2) the second user identifying information that satisfied the first user search parameters; (3) a second user rating; (4) a second user waiting list; and (5) a second user visitation request; and
i. receiving with the transceiver, over the communications network from the first user computing device, selected second user data, wherein the selected second user data is triggered by a gesture received on the first user graphical display proximate to the selected second user graphical indicator displayed on the first user computing device.

2. The computer implemented method of claim 1 further comprising:
a. generating, with the processor, a third user record for each of a plurality of third users, wherein each of the third user records comprises third user data comprising at least one of: (1) third user identifying information; (2) a third user geographic location; (3) third user services; (4) third user goods; (5) third user hours; and (6) a third user price;
b. storing the third user record in the connected database;
c. sending with the transceiver, second user interface data for providing a second user interface configured for receiving second user search parameters input from a second user computing device;
c. receiving with the transceiver, second user search parameters;
d. determining with the processor, at least one of first user records and third user records that satisfy the second user search parameters;
e. sending with the transceiver, over the communications network to the second user computing device of one of the plurality of second users, second graphical display data for displaying a second graphical display comprising a second map and at least one of a first user graphical indicator that corresponds to each of the plurality of first user records that satisfy the second user search parameters and a third user graphical indicator that corresponds to each of the plurality of third user records that satisfy the second user search parameters,
wherein the first user graphical indicator comprises at least one of: (1) the first user record, (2) the first user search parameters, and (2) the first user record that satisfied the second user search parameters; and
wherein the third user graphical indicator comprises at least one of: (1) the third user record, (2) the third user record that satisfied the second user search parameters.

3. The computer implemented method of claim 2 further comprising:
a. sending with the transceiver, third user interface data for providing a third user interface configured for receiving third user search parameters input from a third user computing device;
b. receiving with the transceiver, third user search parameters;
c. determining with the processor, which second user records that satisfy the third user search parameters; and
d. sending with the transceiver, over the communications network to the third user computing device, third graphical display data for displaying a third graphical display comprising a third map and the second user graphical indicator that corresponds to each of the plurality of second user records that satisfy the third user search parameters.

4. The computer implemented method of claim 3 further comprising:
a. sending with the transceiver, over the communications network to the first user computing device, a first communication tool for the first user computing device to communicate with the second user computing device of the selected second user;
b. sending with the transceiver, over the communications network to the second user computing device, a second communication tool for the second user computing device to communicate with the first user computing device of a selected first user and the third user computing device of a selected third user; and
c. sending with the transceiver, over the communications network to the third user computing device, a third communication tool for the third user computing device to communicate with the second user computing device of a third user selected second user.

5. The computer implemented method of claim 4, wherein
a. receiving with the transceiver, over the communications network, from the first user computing device, first user communication request data using the first communication tool displayed on the first user interface; wherein the first user communication request data comprises at least one of (i) a first user request to the second user to visit the second user facility; and (ii) a first user request to the second user to join the second user waiting list;
b. receiving with the transceiver, over the communications network, from the second user computing device, second user communication request data using the second communication tool displayed on the second user interface, wherein the second user communication request data comprises at least one of (i) a second user offer to the first user; (ii) a second user request to the third user for at least one of the third user's goods and the third user's services; (iii) a second user request to the third user to join a third user waiting list for at least one of the third user's goods and the third user's services; and
c. receiving with the transceiver, over the communications network, from the third user computing device, third user communication request data using the third communication tool displayed on the second user interface, wherein the third user communication request data comprises a third user offer to the second user.

6. The computer implemented method of claim 5 further comprising:
a. receiving with the transceiver, second user rating input data from at least one of the first user computing device and the third user computing device corresponding to the selected second user;
b. determining with the processor, the second user rating of the selected second user, wherein the second user rating is defined by an average of a plurality of second user input data;
c. sending with the transceiver, over the communications network to the first user computing device, the first user graphical display data for displaying the first user graphical display consisting of the second user graphical indicator that corresponds to the selected second user, wherein the second user graphical indicator consists of the second user rating; and
d. sending with the transceiver, over the communications network to the third user computing device, third user graphical display data for displaying the third graphical display consisting of the second user graphical indicator that corresponds to the selected second user, wherein the second user graphical indicator consists of the second user rating.

7. The computer implemented method of claim 6 further comprising:
a. receiving with the transceiver, over the communications network from the second user computing device, second user waiting list update data corresponding to changes to the second user waiting list;
b. storing the second user waiting list update data in the corresponding second user record in the connected database; and
c. sending with the transceiver, over the communications network to the first user computing device, update notification data for displaying a graphical update notification on the first user interface.

8. The computer implemented method of claim 7 further comprising:
a. receiving with the transceiver, over the communications network from one of a plurality of the second user computing devices, advertising parameters;
b. storing the advertising parameters in the corresponding second user record in the connected database;
c. determining, with the processor, based on the plurality of first user records and the plurality of third user records, which of at least one of the first user records and the third user records satisfy the advertising parameters, wherein the corresponding at least one of the first user record and the second user record defines a targeted user; and
d. sending with the transceiver, over the communications network to at least one targeted user computing device of a plurality of targeted user computing devices, marketing material from the second user.

9. The computer implemented method of claim 8 further comprising aggregating with the processor, searching data and at least one of: (1) the plurality of first user records, (2) the plurality of second user records, and (3) the plurality of third user records to generate aggregate data.

10. The computer implemented method of claim 9 further comprising sending with the transceiver, over the communications network to the second user computing device, analytics report data for displaying on the second user interface an analytics report comprising an aggregated graphical representation of the aggregate data.

11. A computer implemented method for providing a marketplace for childcare related services between a plurality of first users and a plurality of second users, the computer implemented method comprising:
a. generating, with a processor of a computing device, a first user record for each of the plurality of first users, wherein each of the first user records comprises first user data comprising at least one of: (1) first user identifying information; (2) a first user geographic location; and (3) first user child information;
b. generating, with the processor, a second user record for each of the plurality of second users, wherein each of the second user records comprises second user data comprising at least one of: (1) second user identifying information (2) a second user geographic location; (3) second user services; and (4) a description of a second user facility;
c. storing the first user record and the second user record in a connected database;
d. sending with a transceiver of the computing device, over a communications network to a first user computing device associated with one of the plurality of first users, first user interface data for providing a first user interface configured for receiving first user search parameters input from the first user computing device, wherein the first user search parameters comprise at least one of: (1) a predetermined geographic location; (2) a searching age range; (3) required second user services; and (4) a minimum second user rating;
e. receiving with the transceiver, over the communications network from the first user computing device, the first user search parameters;
f. storing in the connected database, the first user search parameters in the corresponding first user record;
g. determining, with the processor, based on a plurality of second user records, which of the second user records satisfies the first user search parameters;
h. sending with the transceiver, over the communications network to the first user computing device, first user graphical display data for displaying a first user graphical display comprising a map and a second user graphical indicator that corresponds to each of the plurality of second user records that satisfy the first user search parameters,
wherein the second user graphical indicator comprises at least one of: (1) the second user record; (2) the second user identifying information that satisfied the first user search parameters; (3) a second user rating; (4) a second user waiting list; and (5) a second user visitation request;
i. receiving with the transceiver, over the communications network from the first user computing device, selected second user data, wherein the selected second user data is triggered by a gesture received on the first user graphical display proximate to the selected second user graphical indicator displayed on the first user computing device;
j. sending with the transceiver, second user interface data for providing a second user interface configured for receiving second user search parameters input from a second user computing device;
j. receiving with the transceiver, second user search parameters;
l. determining with the processor, which of the first user records satisfy the second user search parameters; and
m. sending with the transceiver, over the communications network to the second user computing device of one of the plurality of second users, second graphical display data for displaying a second graphical display comprising a second map and a first user graphical indicator that corresponds to each of the plurality of first user records that satisfy the second user search parameters; wherein the first user graphical indicator comprises at least one of: (1) the first user record, (2) the first user search parameters, and (3) the first user record that satisfied the second user search parameters.

12. The computer implemented method of claim 11 further comprising:
a. receiving with the transceiver, second user rating input data from the first user computing device corresponding to the selected second user;
b. determining with the processor, the second user rating of the selected second user, wherein the second user rating is defined by an average of a plurality of second user input data; and
c. sending with the transceiver, over the communications network to the first user computing device, the first user graphical display data for displaying the first user graphical display consisting of the second user graphical indicator that corresponds to the selected second user, wherein the second user graphical indicator consists of the second user rating.

13. The computer implemented method of claim 11 further comprising:
a. receiving with the transceiver, over the communications network from the second user computing device, second user waiting list update data corresponding to changes to the second user waiting list;
b. storing the second user waiting list update data in the corresponding second user record in the connected database; and
c. sending with the transceiver, over the communications network to the first user computing device, update notification data for displaying a graphical update notification on the first user interface.

14. The computer implemented method of claim 11 further comprising:
a. receiving with the transceiver, over the communications network from one of a plurality of the second user computing devices, advertising parameters;
b. storing the advertising parameters in the corresponding second user record in the connected database;
c. determining, with the processor, based on a plurality of first user records, which of the first user records satisfy the advertising parameters, wherein the corresponding first user records defines a targeted user; and
d. sending with the transceiver, over the communications network to a targeted user computing device of the targeted user, marketing material from the second user.

15. The computer implemented method of claim 11 further comprising:
a. aggregating with the processor, searching data and at least one of: (1) the plurality of first user records, and (2) the plurality of second user records to generate aggregate data; and
b. sending with the transceiver, over the communications network to the second user computing device, analytics report data for displaying on the second user interface an analytics report comprising an aggregated graphical representation of the aggregate data.

16. A computer implemented method for providing a marketplace for childcare related services between a plurality of first users and a plurality of second users, the computer implemented method comprising:
a. generating, with a processor of a computing device, a first user record for each of the plurality of first users, wherein each of the first user records comprises first user data consisting of: (1) first user identifying information; (2) a first user geographic location; and (3) first user child information;
b. generating, with the processor, a second user record for each of the plurality of second users, wherein each of the second user records comprises second user data consisting of: (1) second user identifying information; (2) a second user geographic location; (3) second user services; (4) a description of a second user facility; (5) a second user price; and (6) second user hours of operation;
c. generating, with the processor, a third user record for each of the plurality of third users, wherein each of the third user records comprises third user data consisting of: (1) third user identifying information; (2) a third user geographic location; (3) third user services; (4) third user goods; (5) third user hours of operation; and (6) a third user price;
d. storing the first user record, the second user record, and the third user record in a connected database;
e. sending with a transceiver of the computing device, over a communications network to a first user computing device associated with one of the plurality of first users, first user interface data for providing a first user interface configured for receiving first user search parameters input from the first user computing device, wherein the first user search parameters comprising at least two of: (1) a predetermined geographic location; (2) a searching age range; (3) required second user services; and (4) a minimum second user rating;
f. receiving with the transceiver, over the communications network from the first user computing device, the first user search parameters;
g. storing in the connected database, the first user search parameters in the corresponding first user record;
h. determining, with the processor, based on a plurality of second user records, which of the second user records satisfies the first user search parameters;
i. sending with the transceiver, over the communications network to the first user computing device, first user graphical display data for displaying a first user graphical display comprising a map and a second user graphical indicator that corresponds to each of the plurality of second user records that satisfy the first user search parameters,
wherein the second user graphical indicator consists of displaying: (1) the second user record; and (2) a second user rating;
j. receiving with the transceiver, over the communications network from the first user computing device, selected second user data, wherein the selected second user data is triggered by a gesture received on the first user graphical display proximate to the selected second user graphical indicator displayed on the first user computing device;
k. sending with the transceiver, over the communications network to the first user computing device, a first communication tool for the first user computing device to communicate with a second user computing device of the selected second user;
l. receiving with the transceiver, over the communications network, from the first user computing device, first user communication request data using the first communication tool displayed on the first user interface; wherein the first user communication request data comprises at least one of (i) a first user request to the second user to visit the second user facility; and (ii) a first user request to the second user to join a second user waiting list;
m. sending with the transceiver, second user interface data for providing a second user interface configured for receiving second user search parameters input from the second user computing device;
n. receiving with the transceiver, second user search parameters;
o. determining with the processor, which of the first user records and third user records satisfy the second user search parameters;
p. sending with the transceiver, over the communications network to the second user computing device of one of the plurality of second users, second graphical display data for displaying a second graphical display comprising a second map and at least one of a first user graphical indicator that corresponds to each of the plurality of first user records that satisfy the second user search parameters and a third user graphical indicator that corresponds to each of the plurality of third user records that satisfy the second user search parameters,
wherein the first user graphical indicator consists of displaying: (1) the first user geographic location, and (2) the first user search parameters;
wherein the third user graphical indicator consists of displaying (1) the third user record, and (2) the third user record that satisfied the second user search parameters;
q. receiving with the transceiver, over the communications network from the second user computing device, at least one of selected first user data and selected third user data, wherein the selected first user data is triggered by the gesture received on the first user graphical display proximate to the selected first user graphical indicator, and wherein the selected third user data is triggered by the gesture received on the second graphical display proximate to the selected third user graphical indicator displayed;
r. sending with the transceiver, over the communications network to the second user computing device, a second communication tool for the second user computing device to communicate with the first user computing device of a selected first user and a third user computing device of a selected third user;
s. receiving with the transceiver, over the communications network, from the second user computing device, second user communication request data using the second communication tool displayed on the second user interface, wherein the second user communication request data comprises at least one of (i) a second user offer to the first user; (ii) a second user request to the third user for at least one of the third user's goods and the third user's services; (iii) a second user request to the third user to join a third user waiting list for at least one of the third user's goods and the third user's services;
t. sending with the transceiver, third user interface data for providing a third user interface configured for receiving third user search parameters input from the third user computing device;
u. receiving with the transceiver, third user search parameters;
v. determining with the processor, which of the second user records satisfy the third user search parameters;
w. sending with the transceiver, over the communications network to the third user computing device, third graphical display data for displaying a third graphical display comprising a third map and the second user graphical indicator that corresponds to each of the plurality of second user records that satisfy the third user search parameters;
x. receiving with the transceiver, over the communications network, from the third user computing device, the selected second user data, wherein the selected second user data is triggered by the gesture received on the third graphical display proximate to the selected second user graphical indicator displayed on the third user computing device;
y. sending with the transceiver, over the communications network to the third user computing device, a third communication tool for the third user computing device to communicate with the second user computing device of a third user selected second user; and
z. receiving with the transceiver, over the communications network, from the third user computing device, third user communication request data using the third communication tool displayed on the third user interface, wherein the third user communication request data comprises a third user offer to the second user.

17. The computer implemented method of claim 16 further comprising:
a. receiving with the transceiver, over the communications network from the second user computing device, second user waiting list update data corresponding to changes to the second user waiting list;
b. storing the second user waiting list update data in the corresponding second user record in the connected database; and
c. sending with the transceiver, over the communications network to the first user computing device, update notification data for displaying a graphical update notification on the first user interface.

18. The computer implemented method of claim 17 further comprising:
a. receiving with the transceiver, over the communications network from one of a plurality of the second user computing devices, advertising parameters;
b. storing the advertising parameters in the corresponding second user record in the connected database;
c. determining, with the processor, based on at least one of the plurality of first user records the plurality of third user records, which of the first user records and the third user records satisfy the advertising parameters, wherein the corresponding first user records and third user records defines a targeted user; and
d. sending with the transceiver, over the communications network to a targeted user computing device of the targeted user, marketing material from the second user.

19. The computer implemented method of claim 18 further comprising:
a. aggregating with the processor, searching data and at least one of: (1) the plurality of first user records, (2) the plurality of second user records, and (3) the plurality of third user records to generate aggregate data; and
b. sending with the transceiver, over the communications network to the second user computing device, analytics report data for displaying on the second user interface an analytics report comprising an aggregated graphical representation of the aggregate data.

20. The computer implemented method of claim 19, further comprising:
a. providing a user interface having a service chart area based on the second user data comprising at least one of second user number of vacancies and second user availability; and
b. an input area that receives a gesture for the first user to at least one of apply online to fill a vacancy of the second user and to be added to the second user waiting list.
